(19) United States
(12) Patent Application Publication
(10) Pub. No.: US 2024/0422794 A1
(43) Pub. Date: Dec. 19, 2024

(54) TRIGGERING A RANDOM ACCESS PROCEDURE DURING A SMALL DATA TRANSMISSION

(71) Applicant: Samsung Electronics Co., Ltd., Suwon-si (KR)

(72) Inventor: Anil Agiwal, Allen, TX (US)

(21) Appl. No.: 18/669,274

(22) Filed: May 20, 2024

Related U.S. Application Data
(60) Provisional application No. 63/472,998, filed on Jun. 14, 2023.
(60) Provisional application No. 63/546,418, filed on Oct. 30, 2023.
(60) Provisional application No. 63/599,905, filed on Nov. 16, 2023.

(51) Int. Cl. H04W 72/231; H04B 17/318; H04W 52/36; H04W 56/00; H04W 74/0816

(52) U.S. Cl. CPC H04W 72/231; H04B 17/328; H04W 52/36; H04W 56/0015; H04W 74/0816

(57) ABSTRACT

A user equipment (UE) includes a transceiver configured to receive a primary downlink control channel (PDCCH) order for a layer1/layer2 triggered mobility (LTM) candidate cell. The UE further includes a processor operatively coupled to the transceiver. The processor is configured to determine, whether a transmission indicator in the PDCCH order indicates an initial transmission or and initialize or increment a retransmission, a PREAMBLE_POWER_RAMPING_COUNTER based on the determination.

### CROSS-REFERENCE TO RELATED APPLICATION(S) AND CLAIM OF PRIORITY

This application claims priority under 35 U.S.C. § 119(e) to U.S. Provisional Patent Application No. 63/472,998 filed on Jun. 14, 2023, U.S. Provisional Patent Application No. 63/546,418 filed on Oct. 30, 2023, and U.S. Provisional Patent Application No. 63/599,905 filed on Nov. 16, 2023. The above-identified provisional patent applications are hereby incorporated by reference in their entirety.

### TECHNICAL FIELD

This disclosure relates generally to wireless networks. More specifically, this disclosure relates to apparatuses and methods for triggering a random access procedure during a small data transmission.

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure provides apparatuses and methods for triggering a random access procedure during a small data transmission.

In one embodiment, a user equipment (UE) is provided. The UE includes a transceiver configured to receive a primary downlink control channel (PDCCH) order for a layer1/layer2 triggered mobility (LTM) candidate cell. The UE further includes a processor operatively coupled to the transceiver. The processor is configured to determine, whether a transmission indicator in the PDCCH order indicates an initial transmission or a retransmission, and initialize or increment a PREAMBLE_POWER_RAMPING_COUNTER based on the determination.

In another embodiment, a method of operating a UE is provided. The method includes receiving a PDCCH order for a LTM candidate cell, and determining, whether a transmission indicator in the PDCCH order indicates an initial transmission or a retransmission. The method further includes initializing or incrementing a PREAMBLE_POWER_RAMPING_COUNTER based on the determination.

In yet another embodiment, a UE is provided. The UE includes a transceiver, and a processor operatively coupled to the transceiver. The processor is configured to, during an ongoing small data transfer procedure, determine whether a synchronization signal-reference signal received power (SS-RSRP) of a synchronization signal block (SSB) selected in a last successfully completed random access procedure during the ongoing SDT procedure is below a threshold, and determine whether a prohibit timer is configured and not running.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of this disclosure;

FIG. 3A illustrates an example UE according to embodiments of the present disclosure;

FIG. 3B illustrates an example gNB according to embodiments of the present disclosure;

FIG. 4 illustrates an example of sidelink communication according to embodiments of the present disclosure;

FIG. 5 illustrates a method for initiation of a random access procedure during a SDT procedure according to embodiments of the present disclosure;

FIG. 6 illustrates another method for initiation of a random access procedure during a SDT procedure according to embodiments of the present disclosure;

FIG. 7 illustrates another method for initiation of a random access procedure during a SDT procedure according to embodiments of the present disclosure;

FIG. 8 illustrates another method for initiation of a random access procedure during a SDT procedure according to embodiments of the present disclosure;

FIG. 9 illustrates another method for initiation of a random access procedure during a SDT procedure according to embodiments of the present disclosure;

FIG. 10 illustrates another method for initiation of a random access procedure during a SDT procedure according to embodiments of the present disclosure;

FIG. 11 illustrates a method for MT-SDT paging monitoring according to embodiments of the present disclosure;

FIG. 12 illustrates a method for RRC connection resumption according to embodiments of the present disclosure; and

FIG. 13 illustrates a method for preamble power ramping adjustment according to embodiments of the present disclosure.

### DETAILED DESCRIPTION

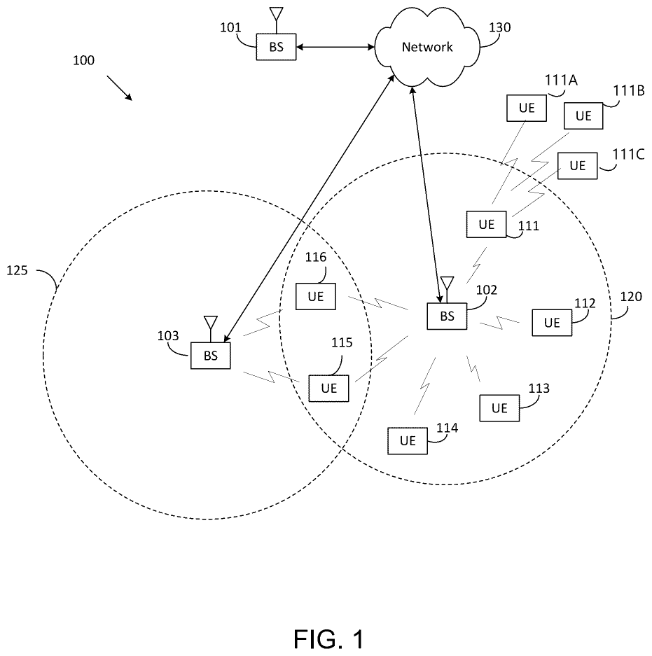

FIGS. 1 through 13, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UEs are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for triggering a random access procedure during a small data transmission. In certain embodiments, one or more of the gNBs 101-103 includes circuitry, programing, or a combination thereof, to support triggering a random access procedure during a small data transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

As discussed in greater detail below, the wireless network 100 may have communications facilitated via one or more devices (e.g., UEs 111A to 111C) that may have a SL communication with the UE 111. The UE 111 can communicate directly with the UEs 111A to 111C through a set of SLs (e.g., SL interfaces) to provide sideline communication, for example, in situations where the UEs 111A to 111C are remotely located or otherwise in need of facilitation for network access connections (e.g., BS 102) beyond or in addition to traditional fronthaul and/or backhaul connections/interfaces. In one example, the UE 111 can have direct communication, through the SL communication, with UEs 111A to 111C with or without support by the BS 102. Various of the UEs (e.g., as depicted by UEs 112 to 116) may be capable of one or more communication with their other UEs (such as UEs 111A to 111C as for UE 111).

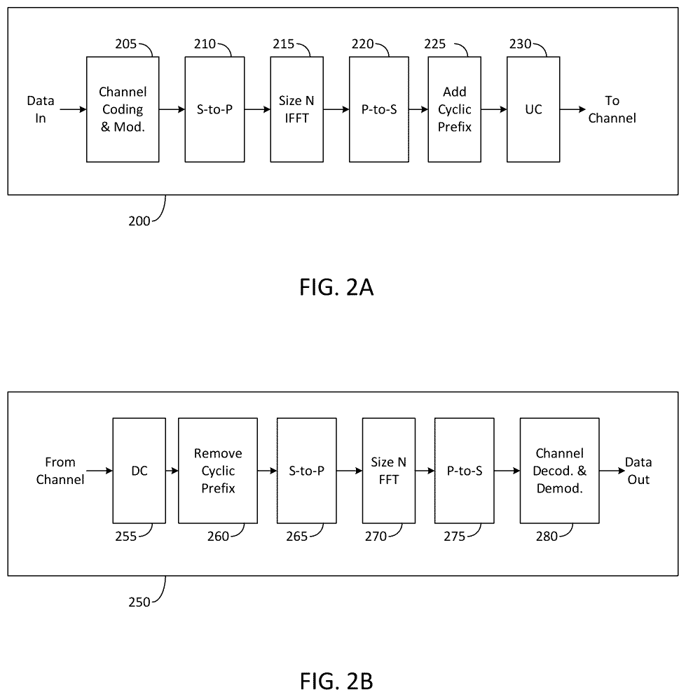

FIGS. 2A and 2B illustrate example wireless transmit and receive paths according to embodiments of this disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280. In some embodiments, the receive path 250 is configured to trigger a random access procedure during a small data transmission.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103. In some embodiments, the transmit path 200 is configured to support triggering a random access procedure during a small data transmission.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

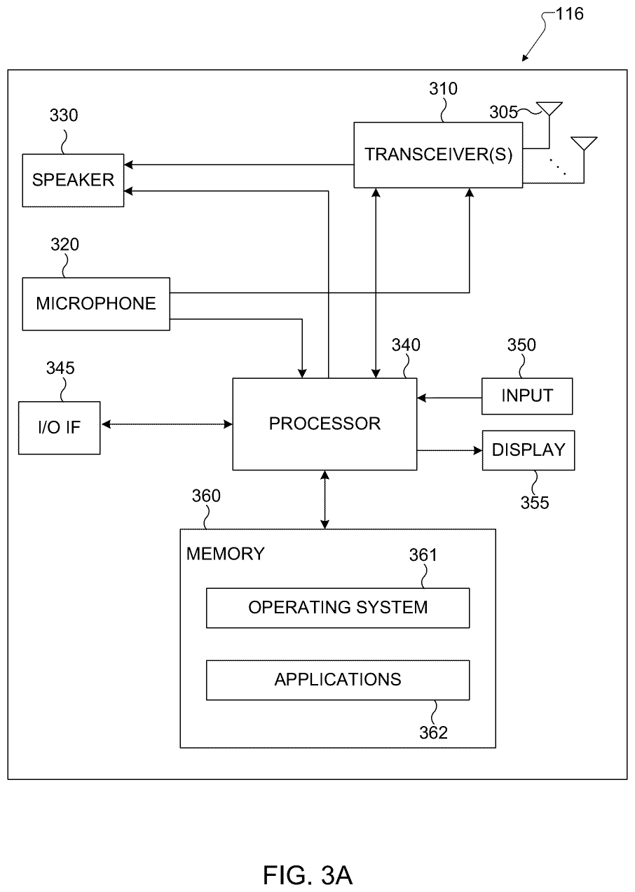

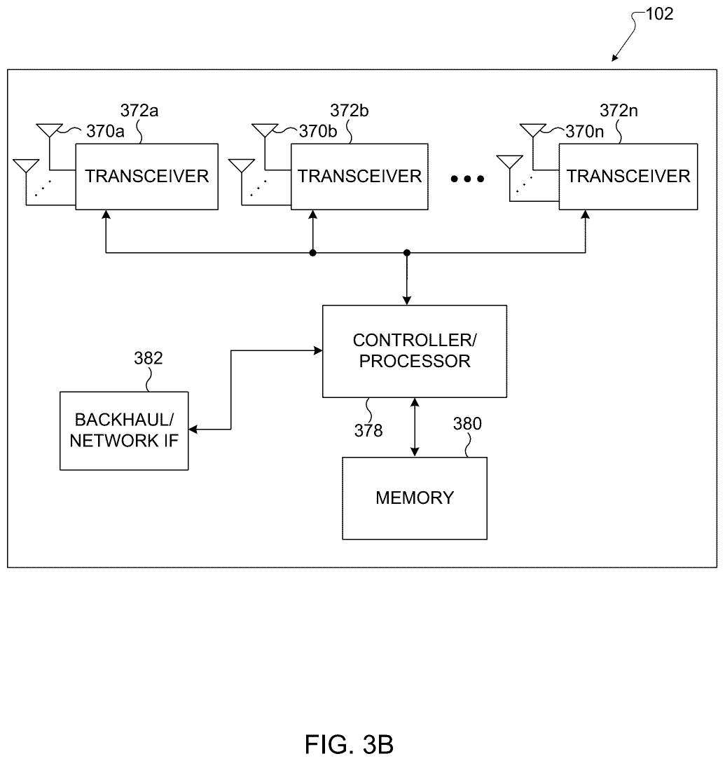

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for triggering a random access procedure during a small data transmission as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support triggering a random access procedure during a small data transmission as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

The fifth-generation wireless communication system supports not only lower frequency bands but also higher frequency (mm Wave) bands, e.g., 10 GHz to 100 GHz bands, so as to accomplish higher data rates. To mitigate propagation loss of radio waves and increase transmission distance, beamforming, massive Multiple-Input Multiple-Output (MIMO), Full Dimensional MIMO (FD-MIMO), array antenna, analog beam forming, and large-scale antenna techniques are being considered in the design of the fifth-generation wireless communication system. In addition, the fifth-generation wireless communication system is expected to address different use cases having quite different requirements in terms of data rate, latency, reliability, mobility etc. However, it is expected that the design of the air-interface of the fifth-generation wireless communication system would be flexible enough to serve UEs having quite different capabilities depending on the use case and market segment the UE caters service to the end customer. Few example, use cases the fifth-generation wireless communication system wireless system is expected to address is enhanced Mobile Broadband (eMBB), massive Machine Type Communication (m-MTC), ultra-reliable low latency communication (URLL) etc. The eMBB requirements like tens of Gbps data rate, low latency, high mobility, etc. address the market segment representing conventional wireless broadband subscribers needing internet connectivity everywhere, all the time and on the go. The m-MTC requirements like very high connection density, infrequent data transmission, very long battery life, low mobility address, etc. address the market segment representing the Internet of Things (IoT)/Internet of Everything (IoE) envisioning connectivity of billions of devices. The URLL requirements like very low latency, very high reliability, and variable mobility, etc. address the market segment representing industrial automation applications, and vehicle-to-vehicle/vehicle-to-infrastructure communication which is foreseen as one of the enablers for autonomous cars.

In the fifth-generation wireless communication system operating in higher frequency (mm Wave) bands, UEs and gNBs communicate with each other using beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in the increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction, and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can be also referred as a transmit (TX) beam. Wireless communication systems operating at high frequency use a plurality of narrow TX beams to transmit signals in the cell as each narrow TX beam provides coverage to a part of cell. The narrower the TX beam, the higher the antenna gain is and hence the larger the propagation distance of a signal transmitted using beamforming. A receiver can also generate plurality of receive (RX) beam patterns of different directions. Each of these receive patterns can be also referred to as a receive (RX) beam.

The fifth generation wireless communication system, supports the standalone mode of operation as well dual connectivity (DC). In DC a multiple Rx/Tx UE may be configured to utilize resources provided by two different nodes (or NBs) connected via a non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in a RRC CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in a RRC_CONNECTED state not configured with CA/DC there is only one serving cell comprising the primary cell. For a UE in a RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR a PCell (primary cell) refers to a serving cell in MCG, operating on the primary frequency, in which the UE either performs the initial connection establishment procedure or initiates the connection re-establishment procedure. In NR for a UE configured with CA, an Scell is a cell providing additional radio resources on top of a Special Cell. A Primary SCG Cell (PSCell) refers to a serving cell in a SCG in which the UE performs random access when performing the Reconfiguration with Sync procedure. For Dual Connectivity operation the term SpCell (i.e., Special Cell) refers to the PCell of the MCG or the PSCell of the SCG. Otherwise, the term Special Cell refers to the PCell.

In the fifth generation wireless communication system, a node B (gNB) or base station in cell broadcast Synchronization Signal and PBCH block (SSB) comprises primary and secondary synchronization signals (PSS, SSS) and system information. System information includes common parameters needed to communicate in cell. In the fifth generation wireless communication system (also referred as next generation radio or NR), System Information (SI) is divided into a master information block (MIB) and a number of system information blocks (SIBs) where the MIB is transmitted on the BCH with a periodicity of 80 ms and repetitions made within 80 ms and the MIB includes parameters that are needed to acquire SIB1 from the cell. The SIB1 is transmitted on the DL-SCH with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand, and, in that case, the configuration needed by the UE to perform the SI request. SIB1 is a cell-specific SIB; SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to different SI messages. Each SI message is transmitted within periodically occurring time domain windows (referred to as SI-windows with the same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as an SI area, which comprises one or several cells and is identified by systemInformationArealD; The mapping of SIBs to SI messages is configured in schedulingInfoList, while the mapping of posSIBs to SI messages is configured in pos-SchedulingInfoList. Each SIB is contained in a single SI message and each SIB and posSIB is contained at most once in that SI message. For a UE in a RRC_CONNECTED state, the network can provide system information through dedicated signaling using the RRCReconfiguration message, e.g., if the UE has an active BWP with no common search space configured to monitor system information, paging, or upon request from the UE. In the RRC_CONNECTED state, the UE acquires the required SIB(s) from the PCell. For PSCell and SCells, the network provides the required SI by dedicated signaling, i.e., within an RRCReconfiguration message. Nevertheless, the UE shall acquire the MIB of the PSCell to get SFN timing of the SCG (which may be different from MCG). Upon change of the relevant SI for a SCell, the network releases and adds the concerned SCell. For a PSCell, the required SI can be changed with Reconfiguration with Sync.

In the 5G wireless communication system, random access (RA) is supported. Random access (RA) is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in an RRC CONNECTED state. Several types of random-access procedure are supported such as contention based random access, and contention free random access, and each of these can be one of 2 step or 4 step random access.

In the fifth generation wireless communication system, a Physical Downlink Control Channel (PDCCH) is used to schedule DL transmissions on PDSCH and UL transmissions on PUSCH, where the Downlink Control Information (DCI) on PDCCH includes: downlink assignments containing at least modulation and coding format, resource allocation, and hybrid-ARQ information related to DL-SCH; and uplink scheduling grants containing at least modulation and coding format, resource allocation, and hybrid-ARQ information related to UL-SCH. In addition to scheduling, PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for PUCCH and PUSCH; transmission of one or more TPC commands for SRS transmissions by one or more UEs; switching a UE's active bandwidth part; and initiating a random access procedure. A UE monitors a set of PDCCH candidates in the configured monitoring occasions in one or more configured COntrol REsource SETs (CORESETs) according to the corresponding search space configurations. A CORESET comprises a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCE. Different code rates for the control channels are realized by aggregating a different number of CCEs. Interleaved and non-interleaved CCE-to-REG mapping is supported in a CORESET. Polar coding is used for PDCCH. Each resource element group carrying PDCCH carries its own DMRS. QPSK modulation is used for PDCCH.

In the fifth-generation wireless communication system, a list of search space configurations is signaled by the GNB for each configured BWP of the serving cell wherein each search configuration is uniquely identified by a search space identifier. The search space identifier is unique amongst the BWPs of a serving cell. An identifier of search space configuration to be used for a specific purpose such as paging reception, SI reception, random access response reception, etc. is explicitly signaled by the gNB for each configured BWP. In NR the search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration where the slot with number ‘x’ in a radio frame with number ‘y’ satisfies the equation below:

$$( y * ( number of slots in a radio frame ) + x - Monitoring - offset - PDCCH - slot ) mod ( Monitoring - periodicity - PDCCH - slot ) = 0$$

The starting symbol of a PDCCH monitoring occasion in each slot having a PDCCH monitoring occasion is given by Monitoring-symbols-PDCCH-within-slot. The length (in symbols) of a PDCCH monitoring occasion is given in the CORESET associated with the search space. The search space configuration includes the identifier of a CORESET configuration associated with the search space. A list of CORESET configurations are signaled by the GNB for each configured BWP of the serving cell wherein each CORESET configuration is uniquely identified by a CORESET identifier. The CORESET identifier is unique amongst the BWPs of a serving cell. Note that each radio frame is of 10 ms duration. The Radio frame is identified by a radio frame number or system frame number. Each radio frame comprises several slots wherein the number of slots in a radio frame and duration of slots depends on sub carrier spacing. The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in the TCI state list is activated and indicated to the UE by the gNB. The TCI state indicates the DL TX beam (the DL TX beam is QCLed with SSB/CSI RS of TCI state) used by the GNB for transmission of the PDCCH in the PDCCH monitoring occasions of a search space.

In the fifth-generation wireless communication system bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring a RRC connected UE with BWP(s) and telling the UE which of the configured BWPs is currently the active one. When BA is configured, the UE only has to monitor PDCCH on the one active BWP i.e., the UE does not have to monitor PDCCH on the entire DL frequency of the serving cell. In the RRC connected state, the UE is configured with one or more DL and UL BWPs, for each configured Serving Cell (i.e., PCell or SCell). For an activated Serving Cell, there is one active UL and DL BWP at any point in time. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signaling, or by the MAC entity itself upon initiation of a random-access procedure. Upon addition of SpCell or activation of an SCell, the DL BWP and UL BWP indicated by firstActiveDownlinkBWP-Id and firstActiveUplinkBWP-Id respectively is active without receiving PDCCH indicating a downlink assignment or an uplink grant. The active BWP for a Serving Cell is indicated by either RRC or PDCCH. For unpaired spectrum, a DL BWP is paired with a UL BWP, and BWP switching is common for both UL and DL. Upon expiry of BWP inactivity timer, the UE switches from the active DL BWP to the default DL BWP or initial DL BWP (if the default DL BWP is not configured).

In the fifth generation wireless communication system, Radio Resource Control (RRC) protocol can be in one of the following states: RRC_IDLE, RRC_INACTIVE, and RRC CONNECTED. A UE is either in the RRC CONNECTED state or in the RRC INACTIVE state when an RRC connection has been established. If this is not the case, i.e., no RRC connection is established, the UE is in the RRC IDLE state. The RRC states can further be characterized as follows:

In the RRC_IDLE state, a UE specific DRX may be configured by upper layers. The UE monitors short Messages transmitted with P-RNTI over DCI; monitors a Paging channel for CN paging using 5G-S-TMSI; performs neighboring cell measurements and cell (re-) selection; acquires system information and can send SI request (if configured); and performs logging of available measurements together with location and time for logged measurement configured UEs.

In the RRC_INACTIVE state, a UE specific DRX may be configured by upper layers or by the RRC layer; the UE stores the UE Inactive AS context; and a RAN-based notification area is configured by the RRC layer. The UE monitors Short Messages transmitted with P-RNTI over DCI; monitors a Paging channel for CN paging using 5G-S-TMSI and RAN paging using full I-RNTI; performs neighboring cell measurements and cell (re-) selection; performs RAN-based notification area updates periodically and when moving outside the configured RAN-based notification area; acquires system information and can send SI request (if configured); and performs logging of available measurements together with location and time for logged measurement configured UEs.

In the RRC_CONNECTED state, the UE stores the AS context and transfer of unicast data to/from the UE takes place. The UE monitors Short Messages transmitted with P-RNTI over DCI, if configured; monitors control channels associated with the shared data channel to determine if data is scheduled for it; provides channel quality and feedback information; and performs neighboring cell measurements and measurement reporting; acquires system information.

In the RRC_CONNECTED state, the network may initiate suspension of the RRC connection by sending a RRCRelease with suspend configuration. When the RRC connection is suspended, the UE stores the UE Inactive AS context and any configuration received from the network, and transits to the RRC_INACTIVE state. If the UE is configured with SCG, the UE releases the SCG configuration upon initiating a RRC Connection Resume procedure. The RRC message to suspend the RRC connection is integrity protected and ciphered.

The resumption of a suspended RRC connection is initiated by upper layers when the UE needs to transit from the RRC_INACTIVE state to the RRC_CONNECTED state or by the RRC layer to perform a RNA update or by RAN paging from NG-RAN. When the RRC connection is resumed, the network configures the UE according to the RRC connection resume procedure based on the stored UE Inactive AS context and any RRC configuration received from the network. The RRC connection resume procedure re-activates AS security and re-establishes SRB(s) and DRB(s). In response to a request to resume the RRC connection, the network may resume the suspended the RRC connection and send the UE to the RRC_CONNECTED state, or reject the request to resume and send the UE to the RRC_INACTIVE state (with a wait timer), or directly re-suspend the RRC connection and send the UE to the RRC_INACTIVE state, or directly release the RRC connection and send the UE to the RRC IDLE state, or instruct the UE to initiate NAS level recovery (in this case the network sends an RRC setup message).

The 5G or Next Generation Radio Access Network (NG-RAN) based on NR comprises NG-RAN nodes where an NG-RAN node is a gNB, providing NR user plane and control plane protocol terminations towards the UE. The gNBs are also connected by means of the NG interfaces to the 5GC, more specifically to the AMF (Access and Mobility Management Function) by means of the NG-C interface and to the UPF (User Plane Function) by means of the NG-U interface. In the 5th generation (also referred to as NR or New Radio) wireless communication system, the UE may use Discontinuous Reception (DRX) in the RRC_IDLE and RRC_INACTIVE state in order to reduce power consumption. In the RRC_IDLE/RRC_INACTIVE state the UE wake ups at regular intervals (i.e., every DRX cycle) for short periods to receive paging, to receive SI update notifications and to receive emergency notifications. A paging message is transmitted using a physical downlink shared channel (PDSCH). A physical downlink common control channel (PDCCH) is addressed to P-RNTI if there is a paging message in the PDSCH. The P-RNTI is common for all UEs. A UE identity (i.e., S-TMSI for RRC_IDLE UE or I-RNTI for RRC_INACTIVE UE) is included in the paging message to indicate paging for a specific UE. The paging message may include multiple UE identities to page multiple UEs. The paging message is broadcasted (i.e., PDCCH is masked with P-RNTI) over a data channel (i.e., PDSCH). SI update and emergency notifications are included in DCI and PDCCH carrying this DCI is addressed to the P-RNTI. In the RRC idle/inactive mode the UE monitors one paging occasion (PO) every DRX cycle. In the RRC idle/inactive mode the UE monitors a PO in an initial DL BWP. In the RRC connected state the UE monitors one or more POs to receive SI update notifications and to receive emergency notifications. In the RRC connected state, the UE can monitor any PO in the paging DRX cycle and monitors at least one PO in the SI modification period. In the RRC idle/inactive mode UE monitors PO every DRX cycle in its active DL BWP. A PO is a set of ‘S’ PDCCH monitoring occasions for paging, where ‘S’ is the number of transmitted SSBs (i.e., the Synchronization Signal and PBCH block (SSB) includes primary and secondary synchronization signals (PSS, SSS) and PBCH) in cell. UE first determines the paging frame (PF) and then determines the PO with respect to the determined PF. One PF is a radio frame (10 ms).
The PF for a UE is the radio frame with system frame number ‘SFN’ which satisfies the equation (SFN+PF_offset) mod T=(T div N)*(UE_ID mod N).
Index (i_s), indicates the index of the PO is determined by i_s=floor (UE_ID/N) mod Ns.
T is the DRX cycle of the UE.
   In the RRC_INACTIVE state, T is determined by the shortest of the UE specific DRX value configured by RRC, UE specific DRX value configured by NAS, and a default DRX value broadcast in system information.
   In the RRC_IDLE state, T is determined by the shortest of UE specific DRX value configured by NAS, and a default DRX value broadcast in system information. If UE specific DRX is not configured by upper layers (i.e., NAS), the default value is applied.
N: number of total paging frames in T
Ns: number of paging occasions for a PF
PF offset: offset used for PF determination
UE_ID: 5G-S-TMSI mod 1024
Parameters Ns, nAndPagingFrameOffset, and the length of default DRX Cycle are signaled in SIB1. The values of N and PF_offset are derived from the parameter nAndPagingFrameOffset. If the UE has no 5G-S-TMSI, for instance when the UE has not yet registered onto the network, the UE shall use as default identity UE_ID=0 in the PF and i_s formulas above.
The PDCCH monitoring occasions for paging are determined based on a paging search space configuration (paging-SearchSpace) signaled by gNB.
When SearchSpaceId=0 is configured for pagingSearchSpace, the PDCCH monitoring occasions for paging are same as for RMSI. When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.
When SearchSpaceId other than 0 is configured for pagingSearchSpace, the UE monitors the (i_s+1)^{th} PO. The PDCCH monitoring occasions for paging are determined based on a paging search space configuration (paging-SearchSpace) signaled by gNB. The PDCCH monitoring occasions for paging which are not overlapping with UL symbols (determined according to tdd-UL-DL-ConfigurationCommon) are sequentially numbered from zero starting from the 1st PDCCH monitoring occasion for paging in the PF. The gNB may signal the parameter firstPDCCH-MonitoringOccasionOfPO for each PO corresponding to a PF. When firstPDCCH-MonitoringOccasionOfPO is signalled, the (i_s+1)^{th} PO is a set of ‘S’ consecutive PDCCH monitoring occasions for paging starting from the PDCCH monitoring occasion number indicated by firstPDCCH-MonitoringOccasionOfPO (i.e., the (i_s+1)^{th} value of the firstPDCCH-MonitoringOccasionOfPO parameter). Otherwise, the (i_s+1)^{th} PO is a set of ‘S’ consecutive PDCCH monitoring occasions for paging starting from the (i_s*S)^{th} PDCCH monitoring occasion for paging. ‘S’ is the number of actual transmitted SSBs determined according to the parameter ssb-PositionsInBurst signalled in SystemInformationBlock1 received from the gNB. The parameter first-PDCCH-MonitoringOccasionOfPO is signaled in SIB1 for paging in an initial DL BWP. For paging in a DL BWP other than the initial DL BWP, the parameter first-PDCCH-MonitoringOccasionOfPO is signaled in the corresponding BWP configuration.

The 4G and 5G wireless communication system supports vehicular communication services. Vehicular communication services, represented by V2X services, can comprise the following four different types: V2V, V2I, V2N and V2P. In the fifth generation (also referred as NR or New Radio) wireless communication system, V2X communication is being enhanced to support enhanced V2X use cases, which are broadly arranged into four use case groups:
1) Vehicles Platooning enables the vehicles to dynamically form a platoon travelling together. All the vehicles in the platoon obtain information from the leading vehicle to manage this platoon. This information allows the vehicles to drive closer than normal in a coordinated manner, going to the same direction and travelling together.
2) Extended Sensors enables the exchange of raw or processed data gathered through local sensors or live video images among vehicles, road site units, devices of pedestrian and V2X application servers. The vehicles can increase the perception of their environment beyond of what their own sensors can detect and have a broader and holistic view of the local situation. High data rate is one of the key characteristics.
3) Advanced Driving enables semi-automated or full-automated driving. Each vehicle and/or RSU shares its own perception data obtained from its local sensors with vehicles in proximity and that allows vehicles to synchronize and coordinate their trajectories or maneuvers. Each vehicle shares its driving intention with vehicles in proximity too.
4) Remote Driving enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are desirable.

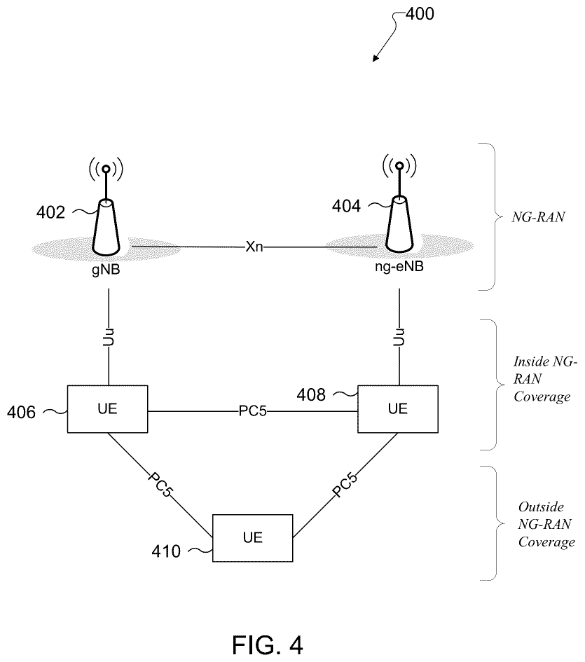

V2X services can be provided by a PC5 interface and/or Uu interface. Support of V2X services via the PC5 interface is provided by NR sidelink communication or V2X sidelink communication, which is a mode of communication whereby UEs can communicate with each other directly over the PC5 interface using NR technology or EUTRA technology respectively without traversing any network node. This communication mode is supported when the UE is served by a RAN and when the UE is outside of the RAN coverage. Only the UEs authorized to be used for V2X services can perform NR or V2X sidelink communication. The NG-RAN architecture supports the PC5 interface as illustrated in FIG. 4

FIG. 4 illustrates an example 400 of sidelink communication according to embodiments of the present disclosure. The embodiment of a sidelink communication in FIG. 4 is for illustration only. Other embodiments of sidelink communication could be used without departing from the scope of this disclosure.

In the example of FIG. 4, a gNB 402 is in communication with an ng-eNB 404 via an Xn interface. gNB 402 and ng-eNB 404 provide NG-RAN coverage. UE 406 and UE 408 are inside the NG-RAN coverage provided by gNB 402 and ng-eNB 404. UE 406 is in communication with 402 via a Uu interface, and UE 408 is in communication with ng-eNB 404 via a Uu interface. UE 406 and UE 408 are also in sidelink communication with each other via a PC5 interface. UE 410, which is outside the NG-RAN coverage provided by NB 402 and ng-eNB 404 is in sidelink communication with UE 406 and UE 408 via separate PC5 interfaces.

Although FIG. 4 illustrates one example 400 of sidelink communication, various changes may be made to FIG. 4. For example, the number of UEs may vary, the number of gNBs may vary, etc. according to particular needs.

Sidelink transmission and reception over the PC5 interface are supported when the UE is inside NG-RAN coverage, irrespective of which RRC state the UE is in, and when the UE is outside NG-RAN coverage. Support of V2X services via the PC5 interface can be provided by NR Sidelink Communication and/or V2X Sidelink Communication. NR Sidelink Communication may be used to support other services than V2X services.

NR or V2X Sidelink Communication can support three types of transmission modes. The first mode is unicast transmission, characterized by: support of at least one PC5-RRC connection between peer UEs; transmission and reception of control information and user traffic between peer UEs in sidelink; support of sidelink HARQ feedback; support of RLC AM; and support of sidelink RLM for both peer UEs to detect RLF. The second mode is groupcast transmission, characterized by: transmission and reception of user traffic among UEs belonging to a group in sidelink; and support of sidelink HARQ feedback. The third mode is broadcast transmission, characterized by: transmission and reception of user traffic among UEs in sidelink.

The AS protocol stack for the control plane in the PC5 interface comprises RRC, PDCP, RLC and MAC sublayer, and the physical layer. The AS protocol stack for user plane in the PC5 interface comprises SDAP, PDCP, RLC and MAC sublayer, and the physical layer. Sidelink Radio bearers (SLRB) are categorized into two groups: sidelink data radio bearers (SL DRB) for user plane data and sidelink signaling radio bearers (SL SRB) for control plane data. Separate SL SRBs using different SCCHs are configured for PC5-RRC and PC5-S signaling respectively.

The MAC sublayer provides the following services and functions over the PC5 interface: —radio resource selection; packet filtering; priority handling between uplink and sidelink transmissions for a given UE; and sidelink CSI reporting. With LCP restrictions in the MAC, sidelink logical channels belonging to the same destination can be multiplexed into a MAC PDU for every unicast, groupcast and broadcast transmission which is associated to the destination. NG-RAN can also control whether a sidelink logical channel can utilize the resources allocated to a configured sidelink grant Type 1. For packet filtering, a SL-SCH MAC header including portions of both Source Layer-2 ID and a Destination Layer-2 ID is added to each MAC PDU. LCID included within a MAC subheader uniquely identifies a logical channel within the scope of the Source Layer-2 ID and Destination Layer-2 ID combination. The following logical channels are used in sidelink:
Sidelink Control Channel (SCCH): a sidelink channel for transmitting control information from one UE to other UE(s);
Sidelink Traffic Channel (STCH): a sidelink channel for transmitting user information from one UE to other UE(s);
Sidelink Broadcast Control Channel (SBCCH): a sidelink channel for broadcasting sidelink system information from one UE to other UE(s).

The following connections between logical channels and transport channels exist:
SCCH can be mapped to SL-SCH;
STCH can be mapped to SL-SCH;
SBCCH can be mapped to SL-BCH.

The RRC sublayer provides the following services and functions over the PC5 interface:
Transfer of a PC5-RRC message between peer UEs;
Maintenance and release of a PC5-RRC connection between two UEs;
Detection of sidelink radio link failure for a PC5-RRC connection.

A PC5-RRC connection is a logical connection between two UEs for a pair of Source and Destination Layer-2 IDs which is considered to be established after a corresponding PC5 unicast link is established. There is one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages are used for a UE to transfer UE capability and sidelink configuration including SLRB configuration to the peer UE. Both peer UEs can exchange their own UE capability and sidelink configuration using separate bi-directional procedures in both sidelink directions. If the UE is not interested in sidelink transmission, if sidelink RLF on the PC5-RRC connection is declared, or if the Layer-2 link release procedure is completed, UE releases the PC5-RRC connection.

The sidelink or PC5 interface supports UE-to-UE direct communication using the sidelink resource allocation modes, physical-layer signals/channels. Two sidelink resource allocation modes are supported: mode 1 and mode 2. In mode 1, the sidelink resource allocation is provided by the network. In mode 2, UE decides the SL transmission resources in the resource pool(s).

A Physical Sidelink Control Channel (PSCCH) indicates resource and other transmission parameters used by a UE for PSSCH. PSCCH transmission is associated with a DM-RS. Sidelink control information (1^{st} stage SCI) is transmitted on the PSCCH.

The Physical Sidelink Shared Channel (PSSCH) transmits the transport blocks (TBs) of data themselves, and control information for HARQ procedures and CSI feedback triggers, etc. control information is referred as 2^{nd} stage SCI. At least 6 OFDM symbols within a slot are used for PSSCH transmission. PSSCH transmission is associated with a DM-RS and may be associated with a PT-RS.

The Physical Sidelink Feedback Channel (PSFCH) carries HARQ feedback over the sidelink from a UE which is an intended recipient of a PSSCH transmission to the UE which performed the transmission. A PSFCH sequence is transmitted in one PRB repeated over two OFDM symbols near the end of the sidelink resource in a slot.

The Sidelink synchronization signal comprises sidelink primary and sidelink secondary synchronization signals (S-PSS, S-SSS), each occupying 2 symbols and 127 subcarriers. The Physical Sidelink Broadcast Channel (PSBCH) occupies 9 and 5 symbols for normal and extended cyclic prefix cases respectively, including the associated DM-RS.

Sidelink HARQ feedback uses PSFCH and can be operated in one of two options. In one option, which can be configured for unicast and groupcast, PSFCH transmits either ACK or NACK using a resource dedicated to a single PSFCH transmitting UE. In another option, which can be configured for groupcast, PSFCH transmits NACK, or no PSFCH signal is transmitted, on a resource that can be shared by multiple PSFCH transmitting UEs.

For transmitting data over the PC5 interface, the transmitter UE first transmits 1^{st} Stage SCI over PSCCH resource. 1^{st} stage SCI includes information about the transport block such as: priority, frequency resource assignment, time resource assignment, resource reservation period, DMRS pattern, 2^{nd} stage SCI format, MCS, number of DMRS port, etc. The transmitter UE then transmits 2^{nd} stage SCI over PSSCH. The second stage SCI includes information such as, HARQ process number, NDI, RV, Source ID, Destination ID, HARQ feedback enabled/disabled indicator, cast type, CSI request, Zone ID, range, etc. The transmitter UE then transmits TB carrying SL MAC PDU over PSSCH.

In the fifth generation wireless communication system a Small Data Transmission (SDT) procedure is also supported in the RRC_INACTIVE state. The SDT procedure is a procedure allowing data transmission while remaining in the RRC_INACTIVE state (i.e., without transitioning to the RRC_CONNECTED state). SDT is enabled on a radio bearer basis and can be initiated either by the UE for MO-SDT (Mobile Originated SDT) or by the network for MT-SDT (Mobile Terminated SDT). SDT for MO-SDT is initiated by the UE if less than a configured amount of UL data awaits transmission across all radio bearers for which MO-SDT is enabled, the DL RSRP is above a configured threshold, and a valid SDT resource is available. SDT for MT-SDT is initiated by the network with an indication to the UE in a paging message when DL data awaits transmission for MT-SDT radio bearers; based on the indication, the UE initiates the SDT for MT-SDT if the DL RSRP is above a configured threshold. When SDT is initiated for MT-SDT by the UE, a resume cause indicating MT-SDT is included in the RRCResumeRequestRRCResumeRequest1. Network can enable either or both of the MO-SDT and MT-SDT in a cell.

The SDT procedure is initiated with either a transmission over RACH (configured via system information) or over Type 1 CG resources (configured via dedicated signaling in RRCRelease). The SDT resources can be configured on an initial BWP for both RACH and CG. RACH and CG resources for SDT can be configured on either or both of NUL and SUL carriers. For RACH, the network configures 2-step and/or 4-step RA resources for SDT. When both 2-step and 4-step RA resources for SDT are configured, the UE selects the RA type based on DL RSRP. If the SDT procedure is initiated for MT-SDT over RACH, only the RACH not configured for SDT can be used by the UE. When SDT resources are not configured for RACH nor CG in the serving cell, only SDT procedure for MT-SDT can be supported. CFRA is not supported for SDT over RACH.

Once initiated, the SDT procedure is terminated successfully after the UE is directed to the RRC IDLE or RRC_INACTIVE state (via RRCRelease) or to the RRC_CONNECTED state (via RRCResume), or unsuccessfully upon cell re-selection, expiry of the SDT failure detection timer, or an RLC entity reaching a configured maximum retransmission threshold. Upon failure of the SDT procedure, the UE transitions to the RRC_IDLE state.

After the initial PUSCH transmission during the SDT procedure, subsequent transmissions are handled differently depending on the type of resource used to initiate the SDT procedure:
When using CG resources, the network can schedule subsequent UL transmissions using dynamic grants or they can take place on the following CG resource occasions. The DL transmissions are scheduled using dynamic assignments. The UE can initiate subsequent UL transmission only after reception of confirmation for the initial PUSCH transmission from the network.
When using RACH resources, the network can schedule subsequent UL and DL transmissions using dynamic UL grants and DL assignments, respectively, after the completion of the RA procedure.

The SDT procedure over CG resources can only be initiated with valid UL timing alignment. The UL timing alignment is maintained by the UE based on a network configured timing alignment timer and DL RSRP of configured number of highest ranked SSBs. Upon expiry of the timing alignment timer, the CG resources are released. Logical channel restrictions can be configured by the network for radio bearers enabled for SDT and are applied by the UE regardless of whether the SDT procedure is initiated with either a transmission over RACH or over Type 1 CG resources.

During an SDT procedure for which a random access procedure was initiated for transmitting message/CCCH message (i.e., the initial RRC RRCResumeRequest/RRCResumeRequest1), also referred as RA-SDT procedure, upon completion of the initial random access procedure and until the completion of SDT procedure, the UE monitors a PDCCH addressed to the C-RNTI wherein the PDCCH is assumed to be QCLed with the SSB selected during the random access procedure. The maximum duration of the SDT procedure depends on the configuration of a SDT failure detection timer (T319a) value. The maximum value of T319a is 4000 ms and during this duration the SSB selected during the initial random access procedure may become unsuitable resulting in the UE missing the PDCCH addressed to the C-RNTI transmitted by the gNB during the SDT procedure. One potential approach to overcome this issue to trigger the random access procedure during the SDT procedure if the SSB selected during the initial random access procedure becomes unsuitable. However, this approach presents two issues. First is how to determine the unsuitability of the SSB i.e., configuration of threshold value to determine the unsuitability of the SSB from the network point of view and selection of threshold to determine the unsuitability of the SSB from the UE point of view. Second is criteria to trigger random access procedure in addition to unsuitability of the SSB selected during the initial random access procedure. Additionally, in case another random access procedure other than initial random access procedure is initiated during the SDT procedure e.g., random access due timing alignment timer expiry or random access due to scheduling request, triggering random access due to SSB unsuitability only considering the unsuitability of SSB selected during the initial random access procedure is not efficient and may trigger random access unnecessarily. Additionally, the criteria to trigger random access procedure need to consider whether SDT procedure is a MO SDT or MT SDT. The present disclosure provides solutions that overcome the above identified issues.

Recently a UE-to-Network Relaying architecture is being studied where a (UE to Network) U2N Relay UE relays the traffic between a Remote UE and network. The UE-to-Network Relay UE enables coverage extension and power saving for the Remote UE. The communication between the UE-to-Network Relay and gNB is based on 5G communication between the UE and a gNB. The communication between the Remote UE and UE-to-Network Relay UE is based on sidelink communication. The UE-to-Network Relay UE can monitor paging for the Remote UE. A U2N Remote UE in an RRC IDLE or RRC INACTIVE state can request the U2N Relay UE to monitor paging for itself. The U2N Relay UE in an RRC IDLE or RRC INACTIVE state monitors paging occasions of its connected U2N Remote UE(s). The U2N Relay UE receives paging messages, checks the 5G-S-TSMI/I-RNTI of U2N Remote UE(s) and sends a PagingRecord IE to the U2N Remote UE over sidelink using a UuMessageTransferSidelink message. The U2N Relay UE in an RRC CONNECTED state either a) monitors paging occasions of its connected U2N Remote UE(s) and receives paging messages or b) receives paging messages in a dedicated RRC message. The U2N Relay UE check the 5G-S-TSMI/I-RNTI of U2N Remote UE(s) in received paging messages and sends a PagingRecord IE to the U2N Remote UE over sidelink. This presents an issue because that PagingRecord includes only the UE identity and access type. As a result, the Remote UE upon receiving the UuMessageTransferSidelink from the Relay UE is not aware of the MT-SDT indication. As a result, the Remote UE may have to monitor the PO itself if it supports if it supports the MT-SDT procedure which is an additional burden and may not be possible if the Remote UE is out of coverage. The present disclosure provides solutions that overcome the above identified issues.

A new type of lower layer mobility also referred as L1/L2-triggered mobility (LTM) is being investigated. The Lower Layer Mobility is based on L1 measurements that are provided by the UE to the serving cell. Based on these measurements a handover is triggered by sending a L1 (e.g. DCI) or L2 (e.g. MAC CE) command. In Lower Layer Mobility, the serving cell change is triggered based on L1 beam measurements instead of L3 cell power and quality measurements that are configured in NR baseline handover of Rel. 15. L3 cell quality measurements are reported only after some Time-to-Trigger (TTT) expires for a measurement event. L3 measurements are also filtered based on the L3 configuration over multiple measurements before reporting. L1 measurements have the benefit that the network can react faster to radio link degradation in the serving link as the network can save the delay introduced by L3 filtering and TTT for the handover decision. This should result in reducing in the number of radio link failures compared to baseline handover. For LTM, the serving cell can configure the UE with one or more candidate LTM cells. A PDCCH order can be sent to the UE to trigger RACH for early TA maintenance of the candidate LTM cell so that at the time of LTM cell switch, latency due to RACH can be avoided.

As per the current operation, the UE receives the PDCCH order for a LTM's candidate cell amongst one or more LTM candidate cells configured to the UE by the gNB for LTM. Upon receiving the PDCCH order:
The UE initiates random access procedure. The UE initializes PREAMBLE_TRANSMISSION_COUNTER to zero. The UE initializes PREAMBLE_POWER_RAMPING_COUNTER to zero.
The UE transmits a PRACH preamble. The UE calculates
PREAMBLE_RECEIVED_TARGET_POWER

PREAMBLE_RECEIVED_TARGET_POWER to preamble ReceivedTargetPower+DELTA_PREAMBLE+(PREAMBLE_POWER_RAMPING_COUNTER−1)×PREAMBLE_POWER_RAMPING_STEP
Transmission power is then calculated by the physical layer based on PREAMBLE_RECEIVED_TARGET_POWER, path loss etc.
Upon PRACH preamble transmission, the random access procedure is considered completed.

An issue with the above operation is that power ramping is not applied. The UE transmits the random access preamble using the power for initial transmission upon receiving the PDCCH order. Note that PDCCH order may indicate initial transmission or retransmission. The present disclosure provides solutions that overcome the above identified issue.

In one embodiment, a UE in a RRC_CONNECTED state/RRC_INACTIVE state receives a RRCRelease message from a gNB. The RRCRelease message includes a suspend configuration. The UE enters/continues in the RRC_INACTIVE state upon receiving a RRCRelease message with the suspend configuration.

While in the RRC_INACTIVE state:
The UE monitors a paging occasion and receives a PDCCH addressed to the UE's P-RNTI in the paging occasion. The DCI in the received PDCCH schedules a DL TB including a paging message. The DL TB is successfully decoded by the UE and the UE receives the paging message. The paging message includes the UE's paging identity (i.e., I-RNTI). The paging message also includes a MT-SDT indication for the UE's paging identity. Alternately, the MT-SDT indication for the UE's paging identity may be received in a paging early indication transmitted before the UE's PF/PO or MT-SDT indication for the UE's paging identity may be received in a payload of low power wakeup signal. Upon receiving the MT-SDT indication:
   The UE initiates an MT SDT procedure. The UE applies the non SDT random access resources/configuration. In other words, the RA-SDT procedure using the non SDT random access resource configuration is initiated wherein a non SDT random access resource configuration is received by the UE from the gNB in system information of a camped cell. The random access resource configuration includes random access resources (e.g., preambles, ROs, power control parameters etc.). For the initiated RA-SDT, the random access procedure is initiated using a non SDT random access resource configuration and the type of random access can be one of 2 step RA or 4 step RA. An initial CCCH message i.e., RRCResumeRequest/RRCResumeRequest1 is transmitted in MsgA or Msg3 during the 2 step RA or 4 step RA procedure respectively. The resume cause in RRCResumeRequest/RRCResumeRequest1 is set to resume cause for MT-SDT. Alternately, instead of using the non SDT random access resources/configuration, the UE may use random access resources/configuration configured for SDT, if configured. If random access resources/configuration for SDT are not configured, the UE uses the non SDT random access resources/configuration.
OR
UL data becomes available for one or more SDT radio bearers
   The UE initiates a MO SDT procedure. The UE applies the random access resources/configuration configured for SDT. In other words, the RA-SDT procedure using the random access configuration for SDT is initiated where a random access resource configuration for SDT is received by the UE from the gNB in system information of a camped cell. The random access resource configuration includes random access resources (e.g., preambles, ROs, power control parameters etc.). For initiated RA-SDT, the random access procedure is initiated using random access resource configuration for SDT and the type of random access can be one of 2 step RA or 4 step RA. An initial CCCH message i.e., RRCResumeRequest/RRCResumeRequest1 is transmitted in MsgA or Msg3 during the 2 step RA or 4 step RA procedure respectively.

Upon initiation of an initial random access procedure for SDT (MO-SDT or MT-SDT) towards the Serving Cell (i.e., camped cell):
The UE first selects the UL carrier (SUL or NUL). If the Serving Cell is configured with supplementary uplink and if the RSRP of the downlink pathloss reference is less than rsrp-ThresholdSSB-SUL, the UE selects the SUL carrier. Otherwise, the UE selects the NUL carrier. rsrp-ThresholdSSB-SUL is received in system information and is the same for all BWPs and random-access configurations of the Serving Cell.
The UE then selects the UL and DL BWP of the selected UL carrier.
The UE then selects the set of random access resources applicable to the current random access procedure (In case of MT_SDT, random access resources associated with SDT are excluded from selection. In case of MO-SDT, random access resources associated with SDT are selected)
The UE then selects a RA type (2 step or 4 step RA)
   if the BWP selected for the random access procedure is configured with both 2-step and 4-step RA type random access resources within the selected set of random access resources and the RSRP of the downlink pathloss reference is above msgA-RSRP-Threshold; or if the BWP selected for the random access procedure is only configured with 2-step RA type random access resources within the selected set of random access resources: the UE selects 2-stepRA. Otherwise, the UE selects 4-stepRA.
The UE then applies the random access configuration of the selected RA type from the set of random access resources selected above and performs the random access procedure.
During the random access procedure, the UE selects a SSB before transmitting Msg1 or MsgA for 2 step and 4 step RA respectively.
   if at least one of the SSBs with SS-RSRP above rsrp-ThresholdSSB is available: the UE selects an SSB with SS-RSRP above rsrp-ThresholdSSB. Otherwise, the UE selects any SSB (e.g., SSB with best SS-RSRP).
      The rsrp-ThresholdSSB used is the one configured in the random-access configuration selected for this random-access procedure. Note that each random-access configuration has its own rsrp-ThresholdSSB.

After the initial random access procedure is successfully completed, the UE monitors PDCCH addressed to C-RNTI received in a random access response of the initial random access procedure until the SDT procedure is terminated/completed. For PDCCH reception, The UE assumes that this PDCCH is QCLed (in the spatial domain) with the SSB selected during the random access procedure. The UE will use the RX beam used to receive the SSB selected during the random access procedure. The gNB transmits the PDCCH using the transmission beam QCLed with the SSB selected during the random access procedure.
Once initiated, the SDT procedure is terminated successfully after the UE is directed to the RRC IDLE or RRC_INACTIVE state (via RRCRelease) or to the RRC_CONNECTED state (via RRCResume), or unsuccessfully upon cell re-selection, expiry of the SDT failure detection timer, or an RLC entity reaching a configured maximum retransmission threshold. SDT failure detection timer is started when SDT procedure is initiated or initial CCCH message is transmitted upon initiation of SDT procedure.

After the initial random access procedure is successfully completed and until the SDT procedure is terminated/completed, zero, one or more random access procedures may be initiated. For example, a random access procedure is initiated by the UE if scheduling request is triggered and there is no valid PUCCH resources for transmitting the scheduling request. A random access procedure is initiated if network sends a PDCCH order during the SDT procedure. A random access procedure may also be initiated according to one or more criteria as described in below embodiments.

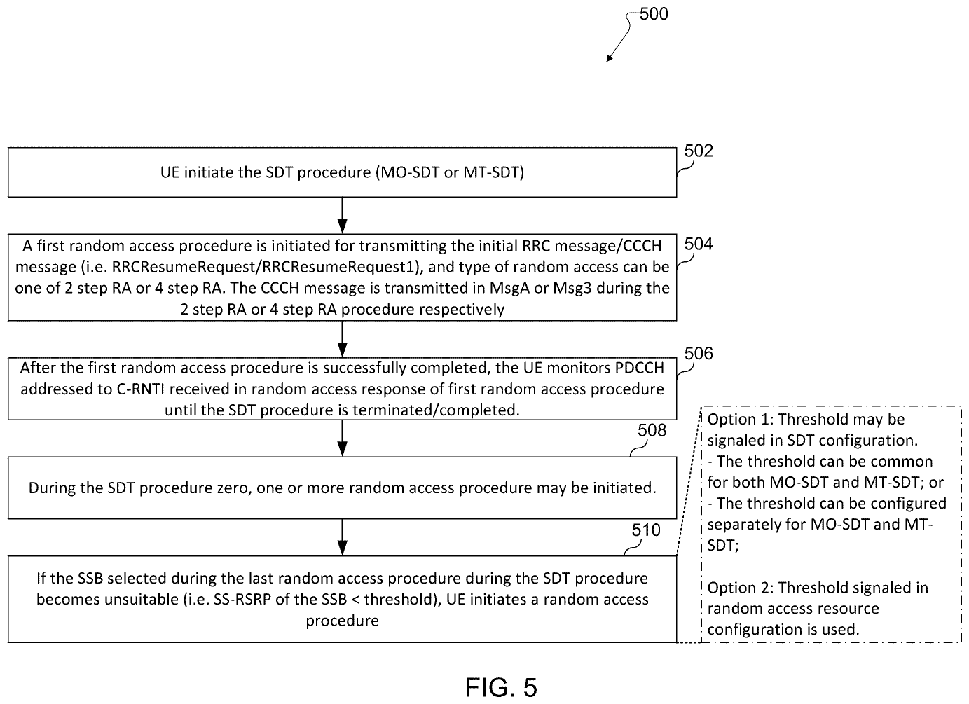

FIG. 5 illustrates a method 500 for initiation of a random access procedure during a SDT procedure according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred to in method 500 are the SSB(s) transmitted by the Serving Cell (i.e., camped cell).

In the example of FIG. 5, method 500 begins at step 502. At step 502 a UE initiates an ongoing SDT procedure (MO-SDT or MT-SDT).

At step 504, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 506, after the first random access procedure is successfully completed, the UE monitors PDCCH addressed to the C-RNTI received in the random access response of the first random access procedure until the SDT procedure is terminated/completed.

At step 508, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY_C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure.

At step 510, if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold): the UE initiates a random access procedure towards the Serving Cell (i.e., camped cell). The UE uses the non SDT random access resources/configuration for this random access procedure.

Alternatively, at step 510, If the SSB selected in the last (or initial) successfully completed random access procedure during the SDT procedure becomes unsuitable (i.e., the SS-RSRP of the selected SSB in the last (or initial) random access procedure during the SDT procedure<threshold) and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer for SDT can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, the threshold is equal to cg-SDT-RSRP-ThresholdSSB signaled in a CG-SDT configuration by the gNB in a RRCRelease.

In one embodiment, the condition “If the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold)” in step 510 can be replaced by “If the SSB selected in the last (or initial) random access procedure during the SDT procedure becomes unsuitable (i.e., the SS-RSRP of the selected SSB in the last (or initial) random access procedure during the SDT procedure<threshold for ‘N’ times or N consecutive times where N is configured by gNB in SIB or RRC message e.g., RRCRelease message).

Although FIG. 5 illustrates one example of a method 500 for initiation of a random access procedure during a SDT procedure, various changes may be made to FIG. 5. For example, while shown as a series of steps, various steps in FIG. 5 could overlap, occur in parallel, occur in a different order, occur any number of times, be omitted, or replaced by other steps.

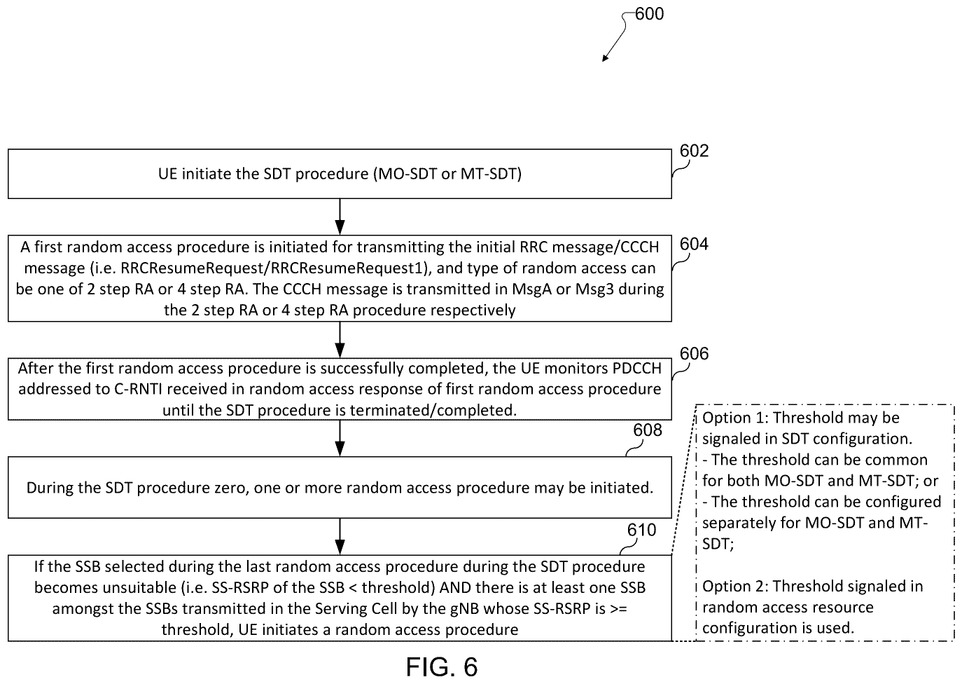

FIG. 6 illustrates another method 600 for initiation of a random access procedure during a SDT procedure according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred to in method 600 are the SSB(s) transmitted by the Serving Cell (i.e., camped cell).

In the example of FIG. 6, method 600 begins at step 602. At step 602 a UE initiates an ongoing SDT procedure (MO-SDT or MT-SDT).

At step 604, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 606, after the first random access procedure is successfully completed, the UE monitors PDCCH addressed to the C-RNTI received in the random access response of the first random access procedure until the SDT procedure is terminated/completed.

At step 608, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure. SSBs transmitted in in the Serving Cell by the gNB can be signaled by the gNB in a SIB e.g., by the parameter ssb-PositionsInBurst in SIB1.

At step 610, if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold1) and there is at least one SSB amongst the SSBs transmitted in the Serving Cell by the gNB whose SS-RSRP is >=threshold2: the UE initiates a random access procedure towards the Serving Cell (i.e., camped cell). The UE uses the non SDT random access resources/configuration for this random access procedure.

Alternatively, at step 610, If the SSB selected in the last (or initial) successfully completed random access procedure during the SDT procedure becomes unsuitable (i.e., the SS-RSRP of the selected SSB in the last (or initial) random access procedure during the SDT procedure<threshold1) and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running and there is at least one SSB amongst the SSBs transmitted in the Serving Cell by the gNB whose SS-RSRP is >=threshold2: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer for SDT can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, threshold1 and threshold2 can be the same and only one threshold is configured/signaled by the gNB.

In one embodiment, the threshold is equal to cg-SDT-RSRP-ThresholdSSB signaled in a CG-SDT configuration by the gNB in a RRCRelease.

In one embodiment, the condition “If the SSB selected in the last (or initial) successfully completed random access procedure during the SDT procedure becomes unsuitable (i.e., the SS-RSRP of the selected SSB in the last (or initial) random access procedure during the SDT procedure<threshold)” in step 510 can be replaced by “If the SSB selected in the last (or initial) successfully completed random access procedure during the SDT procedure becomes unsuitable (i.e., the SS-RSRP of the selected SSB in the last (or initial) random access procedure during the SDT procedure<threshold for ‘N’ times or N consecutive times where N is configured by gNB in SIB or RRC message e.g., RRCRelease message).

Although FIG. 6 illustrates one example of a method 600 for initiation of a random access procedure during a SDT procedure, various changes may be made to FIG. 6. For example, while shown as a series of steps, various steps in FIG. 6 could overlap, occur in parallel, occur in a different order, occur any number of times, be omitted, or replaced by other steps.

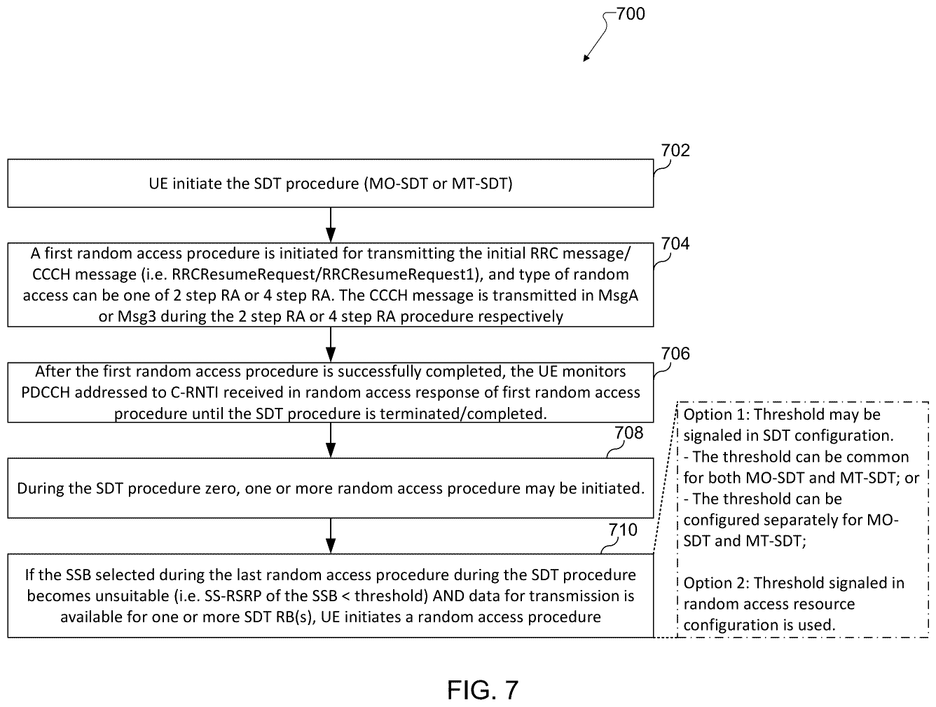

FIG. 7 illustrates another method 700 for initiation of a random access procedure during a SDT procedure according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred to in method 700 are the SSB(s) transmitted by the Serving Cell (i.e., camped cell).

In the example of FIG. 7, method 700 begins at step 702. At step 702 a UE initiates an ongoing SDT procedure (MO-SDT or MT-SDT).

At step 704, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 706, after the first random access procedure is successfully completed, the UE monitors PDCCH addressed to the C-RNTI received in the random access response of the first random access procedure until the SDT procedure is terminated/completed.

At step 708, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY_C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure.

At step 710, if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) and data for transmission is available for one or more SDT RB(s) (or alternately any RB(s)): the UE initiates a random access procedure towards the Serving Cell (i.e., camped cell). The UE uses the non SDT random access resources/configuration for this random access procedure.

Alternatively, at step 710, If the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) and a prohibit timer (the timer can be referred to as a SDT prohibit timer or referred to by other name, the purpose of this timer is to avoid frequent triggering of random access due to the condition ‘SSB selected in the last (or initial) successfully completed random access procedure during the SDT procedure become unsuitable’) is configured and not running and data for transmission is available for one or more SDT RB(s) (or alternately any RB(s)): the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer for SDT can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) successfully completed random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, the threshold is equal to cg-SDT-RSRP-ThresholdSSB signaled in a CG-SDT configuration by the gNB in a RRCRelease.

Although FIG. 7 illustrates one example of a method 700 for initiation of a random access procedure during a SDT procedure, various changes may be made to FIG. 7. For example, while shown as a series of steps, various steps in FIG. 7 could overlap, occur in parallel, occur in a different order, occur any number of times, be omitted, or replaced by other steps.

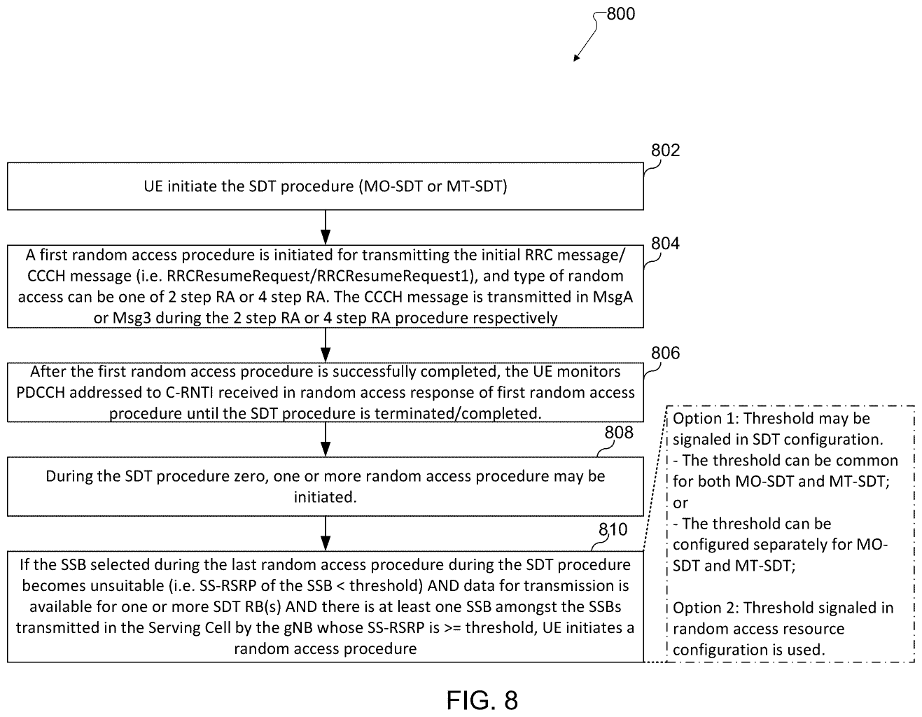

FIG. 8 illustrates another method 800 for initiation of a random access procedure during a SDT procedure according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred to in method 800 are the SSB(s) transmitted by the Serving Cell (i.e., camped cell).

In the example of FIG. 8, method 800 begins at step 802. At step 802 a UE initiates an ongoing SDT procedure (MO-SDT or MT-SDT).

At step 804, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 806, after the first random access procedure is successfully completed, the UE monitors PDCCH addressed to the C-RNTI received in the random access response of the first random access procedure until the SDT procedure is terminated/completed.

At step 808, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY_C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure.

SSBs transmitted in in the Serving Cell by the gNB can be signaled by the gNB in a SIB e.g., by the parameter ssb-PositionsInBurst in SIB1.

At step 810, if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold1), and there is at least one SSB amongst the SSBs transmitted in the Serving Cell by the gNB whose SS-RSRP is >=threshold2, and data for transmission is available for one or more SDT RB(s) (or alternately any RB(s)): the UE initiates a random access procedure towards the Serving Cell (i.e., camped cell). The UE uses the non SDT random access resources/configuration for this random access procedure.

Alternatively, at step 810, If the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold1) and a prohibit timer (the timer can be referred to as a SDT prohibit timer or referred to by other name, the purpose of this timer is to avoid frequent triggering of random access due to the condition ‘SSB selected in the last (or initial) successfully completed random access procedure during the SDT procedure become unsuitable’) is configured and not running, and there is at least one SSB amongst the SSBs transmitted in the Serving Cell by the gNB whose SS-RSRP is >=threshold2, and data for transmission is available for one or more SDT RB(s) (or alternately any RB(s)): the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, threshold1 and threshold2 can be the same and only one threshold is configured/signaled by the gNB.

In one embodiment, the threshold is equal to cg-SDT-RSRP-ThresholdSSB signaled in a CG-SDT configuration by the gNB in a RRCRelease.

In one embodiment, the condition “If the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold)” in step 510 can be replaced by “If the SSB selected in the last (or initial) random access procedure during the SDT procedure becomes unsuitable (i.e., the SS-RSRP of the selected SSB in the last (or initial) successfully completed random access procedure during the SDT procedure<threshold for ‘N’ times or N consecutive times where N is configured by gNB in SIB or RRC message e.g., RRCRelease message).

Although FIG. 8 illustrates one example of a method 800 for initiation of a random access procedure during a SDT procedure, various changes may be made to FIG. 8. For example, while shown as a series of steps, various steps in FIG. 8 could overlap, occur in parallel, occur in a different order, occur any number of times, be omitted, or replaced by other steps.

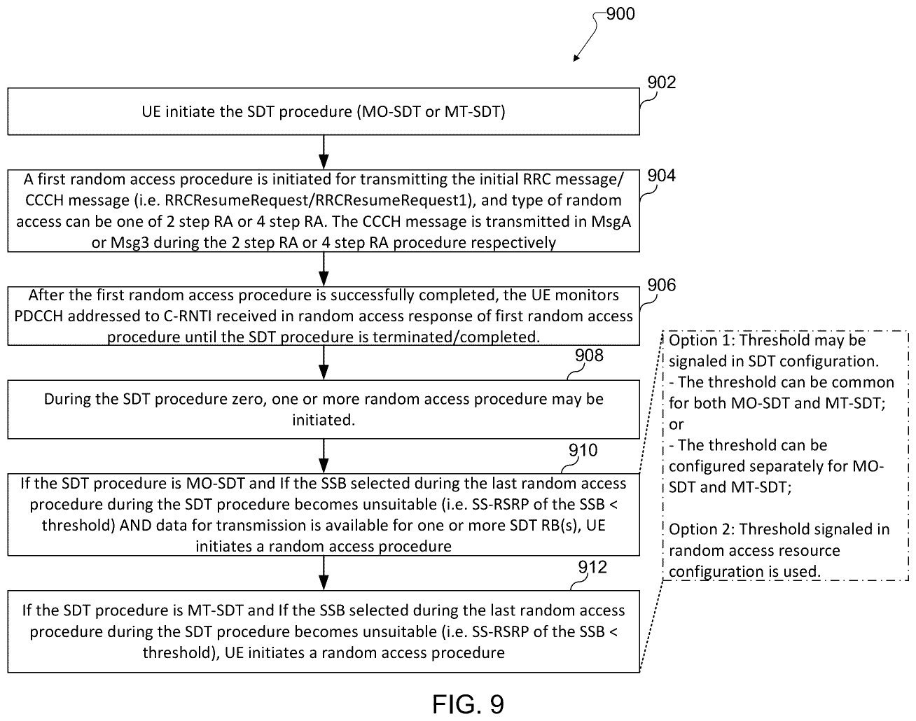

FIG. 9 illustrates another method 900 for initiation of a random access procedure during a SDT procedure according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred in operation are the SSB(s) transmitted by the Serving Cell (i.e., camped cell).

In the example of FIG. 9, method 900 begins at step 902. At step 902 a UE initiates an ongoing SDT procedure (MO-SDT or MT-SDT).

At step 904, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 906, after the first random access procedure is successfully completed, the UE monitors PDCCH addressed to the C-RNTI received in the random access response of the first random access procedure until the SDT procedure is terminated/completed.

At step 908, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY_C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure.

At step 910, if the SDT procedure is MO-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) and data for transmission is available for one or more SDT RB(s) (or alternately any RB(s)): the UE initiates a random access procedure towards the Serving Cell (i.e., camped cell). The UE uses the non SDT random access resources/configuration for this random access procedure.

Otherwise, at step 912, if the SDT procedure is MT-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) the UE initiates a random access procedure towards the Serving Cell (i.e., camped cell). The UE uses the non SDT random access resources/configuration for this random access procedure.

Alternatively, at step 910, if the SDT procedure is MO-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) and data for transmission is available for one or more SDT RB(s) (or alternately any RB(s)) and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer for SDT can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

Otherwise, at step 912, if the SDT procedure is MT-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold) and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, the threshold is equal to cg-SDT-RSRP-ThresholdSSB signaled in a CG-SDT configuration by the gNB in a RRCRelease.

In one embodiment, the condition “If the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold)” in step 510 can be replaced by “If the SSB selected in the last (or initial) random access procedure during the SDT procedure becomes unsuitable (i.e., the SS-RSRP of the selected SSB in the last (or initial) successfully completed random access procedure during the SDT procedure<threshold for ‘N’ times or N consecutive times where N is configured by gNB in SIB or RRC message e.g., RRCRelease message).

Although FIG. 9 illustrates one example of a method 900 for initiation of a random access procedure during a SDT procedure, various changes may be made to FIG. 9. For example, while shown as a series of steps, various steps in FIG. 9 could overlap, occur in parallel, occur in a different order, occur any number of times, be omitted, or replaced by other steps.

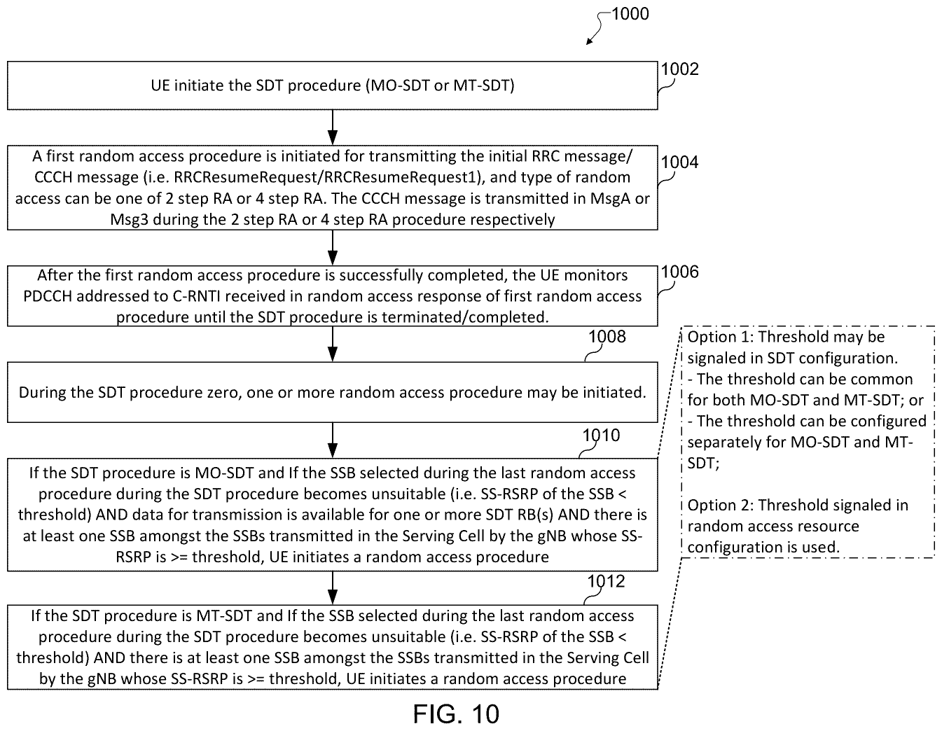

FIG. 10 illustrates another method 1000 for initiation of a random access procedure during a SDT procedure according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments for initiation of a random access procedure during a SDT procedure could be used without departing from the scope of this disclosure. SSB(s) referred in operation are the SSB(s) transmitted by the Serving Cell (i.e., camped cell).

In the example of FIG. 10, method 1000 begins at step 1002. At step 1002 a UE initiates an ongoing SDT procedure (MO-SDT or MT-SDT).

At step 1004, a first random access procedure is initiated for transmitting an initial RRC message/CCCH message (i.e., RRCResumeRequest/RRCResumeRequest1). The type of random access can be one of 2 step RA or 4 step RA. The CCCH message is transmitted in MsgA or Msg3 during the 2 step RA or 4 step RA procedure respectively.

At step 1006, after the first random access procedure is successfully completed, the UE monitors PDCCH addressed to the C-RNTI received in the random access response of the first random access procedure until the SDT procedure is terminated/completed.

At step 1008, during the SDT procedure, one or more random access procedures may be initiated. This random access procedure triggered while the SDT procedure is ongoing can be a 4 step random access procedure or can be a 2 step random access procedure. If this random access procedure is a 4 step random access procedure, the UE transmits a random access preamble, receives a random access response upon transmitting the random access preamble, transmits a Msg3 in a UL grant received in the random access response and starts a contention resolution timer, The UE monitors PDCCH addressed to the C-RNTI while the contention resolution timer is running. If PDCCH addressed to the C-RNTI is received, the UE considers this Contention Resolution successful; stops ra-ContentionResolutionTimer; discards the TEMPORARY_C-RNTI received in random access response; and considers this random access procedure successfully completed. If this random access procedure is 2 step random access procedure, the UE transmits a random access preamble, the UE transmits a MsgA MAC PDU and starts a response window, the UE monitors PDCCH addressed to the C-RNTI while the response window is running. If PDCCH addressed to the C-RNTI is received, the UE considers this random access response reception is successful; stops the response window; and considers this random access procedure successfully completed. During this random access procedure, the UE may indicate in the Msg3 or MsgA whether the SSB selected during this random access procedure is above a threshold or not. The SSB is selected before the random access preamble transmission. Alternately, the UE may indicate in the Msg3 or MsgA that no SSB with SS-RSRP above threshold is available. The SSB is selected before the random access preamble transmission. If there is no SSB with SS-RSRP above threshold, network may send RRCRelease message to terminate the SDT procedure.

SSBs transmitted in in the Serving Cell by the gNB can be signaled by the gNB in a SIB e.g., by the parameter ssb-PositionsInBurst in SIB1.

At step 1010, if the SDT procedure is MO-SDT and if the SSB selected in the last (or initial) random access procedure during the SDT procedure becomes unsuitable (i.e., the SS-RSRP of the selected SSB in the last (or initial) random access procedure during the SDT procedure<threshold1) there is at least one SSB amongst the SSBs transmitted in the Serving Cell by the gNB whose SS-RSRP is >=threshold2 and data for transmission is available for one or more SDT RB(s) (or alternately any RB(s)): the UE initiates a random access procedure towards the Serving Cell (i.e., camped cell). The UE uses the non SDT random access resources/configuration for this random access procedure.

Otherwise, at step 1012, if the SDT procedure is MT-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold 1) and there is at least one SSB amongst the SSBs transmitted in the Serving Cell by the gNB whose SS-RSRP is >=threshold2 the UE initiates a random access procedure towards the Serving Cell (i.e., camped cell). The UE uses the non SDT random access resources/configuration for this random access procedure.

Alternatively, at step 1010, if the SDT procedure is MO-SDT and if the SSB selected in the last (or initial) successfully completed random access procedure during the SDT procedure becomes unsuitable (i.e., the SS-RSRP of the selected SSB in the last (or initial) successfully completed random access procedure during the SDT procedure<threshold1) and there is at least one SSB amongst the SSBs transmitted in the Serving Cell by the gNB whose SS-RSRP is >=threshold2 and data for transmission is available for one or more SDT RB(s) (or alternately any RB(s)) and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) successfully completed random access procedure during the SDT procedure become unsuitable’. This prohibit timer may be stopped (if running) when the SDT procedure is completed.

Otherwise, at step 1012, if the SDT procedure is MT-SDT and if the SSB selected in the last (or initial) successfully completed random access procedure during the SDT procedure becomes unsuitable (i.e., the SS-RSRP of the selected SSB in the last (or initial) random access procedure during the SDT procedure<threshold1) AND there is at least one SSB amongst the SSBs transmitted in the Serving Cell by the gNB whose SS-RSRP is >=threshold2 and a prohibit timer (the timer can be referred to as a SDT prohibit timer or referred to by other name, the purpose of this timer is to avoid frequent triggering of random access due to the condition ‘SSB selected in the last (or initial) random access procedure during the SDT procedure become unsuitable’) is configured and not running: the UE initiates a random access procedure towards the Serving Cell (i.e. camped cell). The UE uses the non SDT random access resources/configuration for this random access procedure. The UE may start a prohibit timer (the timer can be referred to as a SDT prohibit timer or referred to by other name) when this random access procedure is initiated. The value/configuration of this prohibit timer can be received by the UE in system information (e.g., SIB) or in a RRC message (e.g., RRCRelease message) from the gNB. Note that here the prohibit timer is the timer to avoid frequent triggering of random access due to the condition ‘SSB selected in the last (or initial) random access procedure during the SDT procedure become unsuitable’. This prohibit timer may be stopped (if running) when the SDT procedure is completed.

After this random access procedure is successfully completed, the UE monitors PDCCH addressed to the ‘C-RNTI received during the initial random access procedure’ until the SDT procedure is terminated/completed. For PDCCH reception, the UE assumes that this PDCCH is QCLed (in the spatial domain) with the SSB selected during this (i.e., latest) completed random access procedure. The UE will use the RX beam used to receive the SSB selected during this random access procedure. The gNB transmits the PDCCH using the transmission beam QCLed with SSB selected during this (i.e., latest) random access procedure.

In one embodiment, the threshold is signaled in a SDT configuration wherein the SDT configuration is either received in a RRCRelease message from the gNB or in system information from the gNB of the Serving Cell. The threshold can be common for both MO-SDT and MT-SDT. Alternately, the threshold can be configured separately for MO-SDT and MT-SDT; The UE applies the threshold from the MO-SDT configuration if the ongoing SDT procedure is MO-SDT; The UE applies the threshold from the MT-SDT configuration if the ongoing SDT procedure is MT-SDT; In one embodiment, the UE applies the threshold from MO-SDT configuration if the ongoing SDT procedure is MT-SDT and threshold is not configured in the MT-SDT configuration.

In one embodiment, the threshold signaled in the random-access resource configuration which was selected for initial random access initiated upon initiation of the SDT procedure is used.

In one embodiment, the threshold signaled in the random-access resource configuration which was selected for the last random-access procedure initiated during the ongoing SDT procedure is used.

In one embodiment, the threshold signaled in the random-access resource configuration is used.

In one embodiment, threshold1 and threshold2 can be same and only one threshold is configured/signaled by the gNB.

In one embodiment, the threshold is equal to cg-SDT-RSRP-ThresholdSSB signaled in a CG-SDT configuration by the gNB in a RRCRelease.

In one embodiment, the condition “If the SSB selected in the last (or initial) random access procedure during the SDT procedure becomes unsuitable (i.e., the SS-RSRP of the selected SSB in the last (or initial) random access procedure during the SDT procedure<threshold)” in step 510 can be replaced by “If the SSB selected in the last (or initial) random access procedure during the SDT procedure becomes unsuitable (i.e., the SS-RSRP of the selected SSB in the last (or initial) random access procedure during the SDT procedure<threshold for ‘N’ times or N consecutive times where N is configured by gNB in SIB or RRC message e.g., RRCRelease message).

Although FIG. 10 illustrates one example of a method 1000 for initiation of a random access procedure during a SDT procedure, various changes may be made to FIG. 10. For example, while shown as a series of steps, various steps in FIG. 10 could overlap, occur in parallel, occur in a different order, occur any number of times, be omitted, or replaced by other steps.

In one embodiment, a remote UE is in a RRC_IDLE or RRC_INACTIVE state. The remote UE sends its 5G-S-TMSI to a relay UE; the remote UE sends its I-RNTI, if the remote UE is in a RRC_INACTIVE state. The remote UE in a RRC_IDLE state also sends its UE specific DRX cycle (if configured by an upper layer e.g., NAS) to the relay UE for requesting to perform PO monitoring. The remote UE in a RRC_INACTIVE state sends the minimum value of two UE specific DRX cycles (if configured respectively by an upper layer and NG-RAN) to the relay UE for PO monitoring. If the remote UE supports MT-SDT indication (or if the remote UE is in a RRC_INACTIVE state and it supports MT-SDT procedure; or if the remote UE is in a RRC_INACTIVE state and the remote UE supports a MT-SDT procedure and the camped cell supports the MT-SDT procedure), the remote UE may indicate to the relay UE to monitor a MT-SDT indication in paging or the remote UE may indicate to the relay UE that it supports MT-SDT. These parameters can be sent by the remote UE to the relay UE using a RRC signaling message over a sidelink signaling radio bearer (SL SLRB) or over a sidelink data radio bearer. The signaling message (e.g., RemoteUEInformationSidelink) carrying these parameters is transmitted in a MAC PDU wherein the remote UE's layer 2 identity (or part of the remote UE's layer 2 identity) and relay UE's layer 2 identity (part of relay UE's layer 2 identity) is added in a header of the MAC PDU. The MAC PDU is then transmitted over PSSCH.

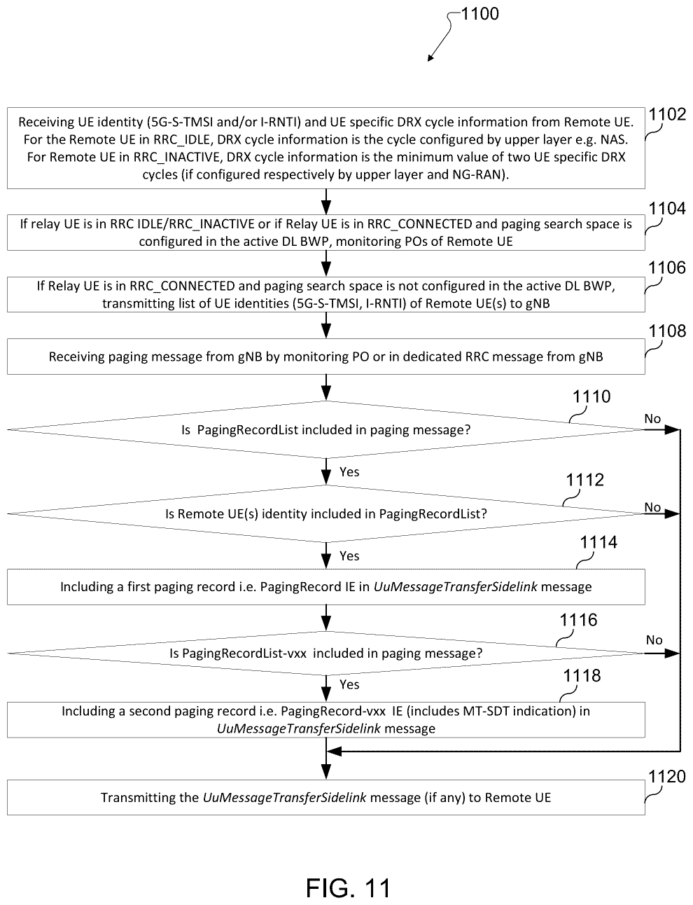

Upon receiving the message from remote UE(s) for monitoring paging, the relay UE performs the operation illustrated in FIG. 11.

FIG. 11 illustrates a method 1100 for MT-SDT paging monitoring according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments for MT-SDT paging monitoring could be used without departing from the scope of this disclosure.

In the example of FIG. 11, method 1100 begins at step 1102. At step 1102, a relay UE receives a UE identity (5G-S-TMSI and/or I-RNTI) and UE specific DRX cycle information from a remote UE. For a remote UE in a RRC_IDLE state, the DRX cycle information is the cycle configured by an upper layer e.g., NAS. For a remote UE in a RRC_INACTIVE state, the DRX cycle information is the minimum value of two UE specific DRX cycles (if configured respectively by the upper layer and NG-RAN).

At step 1104, if the relay UE is in a RRC IDLE or RRC INACTIVE state, or if the relay the UE is in a RRC CONNECTED state and paging search space is configured in the active DL BWP, the UE monitors paging occasions of the remote UE(s). The paging occasions are determined as explained earlier based on information (5G-S-TMSI, UE specific DRX cycle) received from the remote UE and information received from the gNB (default DRX cycle and paging parameters such as the number of paging occasions (Ns), number of paging frames (N) and paging offset). In the monitored paging occasion(s), the relay UE receives PDCCH addressed to a P-RNTI based on which it decodes the DL TB including the paging message.

At step 1106, if paging search space is not configured in the active DL BWP, the relay UE sends a list of UE identities (5G-S-TMSI, I-RNTI) received from remote UE(s) to the gNB in a dedicated RRC message (e.g., SidelinkUEInformationNR). If there is paging for one or more UE identities received from the relay UE, at step 1108 the gNB sends a paging message including information about the paged UEs to the relay UE in a dedicated RRC message (e.g., RRCReconfiguration message). Paging message includes PagingRecordList (list of PagingRecord, paging record includes UE identity and optionally access type indicating non3GPP) and optionally another PagingRecordList such as PagingRecordList-vxx (list of PagingRecord-vxx, PagingRecord-vxx includes MT SDT indication).

At step 1110, the UE determines if the received paging message includes PagingRecordList. If PagingRecordList is included in the paging message, the method proceeds to step 1112. Otherwise, the method proceeds to step 1120.

At step 1120, the UE determines if an entry (say kth, k is an integer) in PagingRecordList includes the UE identity (5G-S-TMSI or I-RNTI) of a remote UE which the relay UE has received from remote UE. If a remote UE(s) identity is included in PagingRecordList, the method proceeds to step 1114. Otherwise, the method proceeds to step 1120.

At step 1114, the relay UE includes a first paging record i.e., PagingRecord IE in a UuMessageTransferSidelink message. The PagingRecord is the one which is included in PagingRecordList and includes the Remote UE's identity. The first paging record comprises the UE identity and optionally access type indicating non3GPP.

At step 1116, the relay UE determines if the received paging message includes PagingRecordList-vxx (or if the received paging message includes PagingRecordList-vxx and Remote UE has indicated to Relay UE that it supports MT-SDT). If PagingRecordList-vxx is included in the paging message, the method proceeds to step 1118. Otherwise, the method proceeds to step 1120.

At step 1118, the relay UE includes a second paging record i.e., PagingRecord-vxx IE in the UuMessageTransferSidelink message. The PagingRecord-vxx is the one which is included in the kth entry in PagingRecordList-vxx where k is the entry number in PagingRecordList which includes the remote UE's UE identity.

At step 1120, the relay UE transmits/sends the UuMessageTransferSidelink to the remote UE.

Although FIG. 11 illustrates one example of a method 1100 for MT-SDT paging monitoring, various changes may be made to FIG. 11. For example, while shown as a series of steps, various steps in FIG. 11 could overlap, occur in parallel, occur in a different order, occur any number of times, be omitted, or replaced by other steps.

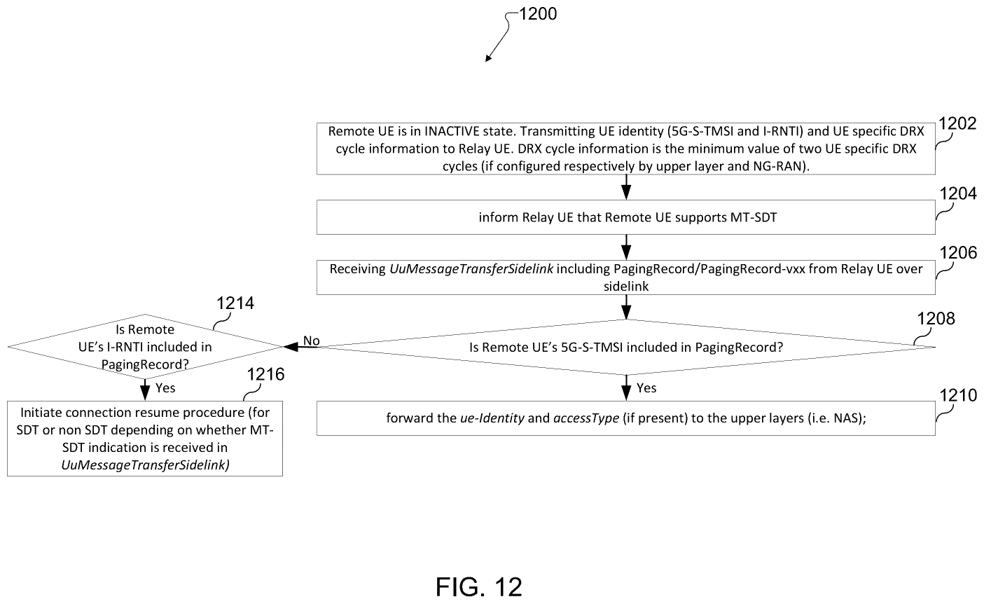

Upon receiving the message i.e., UuMessageTransferSidelink from the relay UE including, pagingGroupList or PagingRecord/PagingRecord-vxx, the remote UE performs the operation shown in FIG. 12 if in an RRC_INACTIVE state.

FIG. 12 illustrates a method 1200 for RRC connection resumption according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for RRC connection resumption could be used without departing from the scope of this disclosure.

In the example of FIG. 12, method 1200 begins at step 1202. At step 1202, the remote UE is in an inactive state. The remote UE transmits its UE identity (5G-S-TMSI and I-RNTI) and UE specific DRX cycle information to the relay UE. The DRX cycle information is the minimum value of two UE specific DRX cycles (if configured respectively by the upper layer and NG-RAN). At step 1204, the remote UE informs the relay UE that the remote UE supports MT-SDT.

At step 1206, while in the inactive state, the UE receives a UuMessageTransferSidelink message including PagingRecord PagingRecord-vxx from the relay UE over sidelink.

At step 1208, the remote UE determines if the Remote UE's 5G-S-TMSI is included in PagingRecord. If the remote UE's 5G-S-TMSI is included in PagingRecord, the method proceeds to step 1210. Otherwise, the method proceeds to step 1214.

At step 1210, if the ue-Identity included in the PagingRecord matches the UE identity allocated by upper layers, the remote UE forwards the ue-Identity and access Type (if present) to the upper layers (i.e., NAS), and performs the actions upon going to a RRC_IDLE state as specified in 5.3.11 with release cause ‘other’.

At step 1214, the remote UE determines if the remote UE's I-RNTI is included in PagingRecord. If the remote UE's I-RNTI is included in PagingRecord, the method proceeds to step 1216.

At step 1216, the remote UE initiates a RRC connection resume procedure (for SDT or non SDT depending on whether MT-SDT indication is received in UuMessageTransferSidelink).

In one embodiment, if the UE is configured by upper layers with Access Identity 1, the remote UE initiates the RRC connection resumption procedure with resumeCause set to mps-PriorityAccess. Otherwise, if the remote UE is configured by the upper layers with Access Identity 2, the remote UE initiates the RRC connection resumption procedure with resumeCause set to mcs-PriorityAccess. Otherwise, if the remote UE is configured by the upper layers with one or more Access Identities equal to 11-15, the remote UE initiates the RRC connection resumption procedure with resumeCause set to highPriorityAccess. Otherwise, if a MT-SDT indication is included in the UuMessageTransferSidelink message received from the relay UE, the remote UE initiates the RRC connection resumption procedure with resumeCause set to mt-SDT. Otherwise, the remote UE initiates the RRC connection resumption procedure with resumeCause set to mt-Access.

In one embodiment, if a MT-SDT indication is included in the UuMessageTransferSidelink message received from the relay UE, the remote UE initiates the RRC connection resumption procedure with resumeCause set to mt-SDT. Otherwise, if the remote UE is configured by the upper layers with Access Identity 1, the remote UE initiates the RRC connection resumption procedure with resumeCause set to mps-PriorityAccess. Otherwise, if the remote UE is configured by upper layers with Access Identity 2, the remote UE initiates the RRC connection resumption procedure with resumeCause set to mcs-PriorityAccess. Otherwise, if the remote UE is configured by the upper layers with one or more Access Identities equal to 11-15, the remote UE initiates the RRC connection resumption procedure with resumeCause set to highPriorityAccess. Otherwise, the remote UE initiates the RRC connection resumption procedure with resumeCause set to mt-Access.

In one embodiment, when the remote UE initiates the RRC connection resumption procedure with resumeCause set to mt-SDT, the remote UE sends RRCResumeRequest/RRCResumeRequest1 to the gNB with resumeCause set to mt-SDT via the relay UE, wherein RRCResumeRequest/RRCResumeRequest1 is sent to the relay UE over sidelink, which then sends the RRCResumeRequest/RRCResumeRequest1 to the gNB over a Uu interface (direct link between the relay UE and the gNB).

In one embodiment, when the remote UE initiates the RRC connection resumption procedure with resumeCause set to mt-SDT, the remote UE sends RRCResumeRequest/RRCResumeRequest1 to the gNB with resumeCause set to mt-SDTdirectly to the gNB over the Uu interface.

Although FIG. 12 illustrates one example of a method 1200 for RRC connection resumption, various changes may be made to FIG. 12. For example, while shown as a series of steps, various steps in FIG. 12 could overlap, occur in parallel, occur in a different order, occur any number of times, be omitted, or replaced by other steps.

One example of encoding UuMessageTransferSidelink message is as follows:

UuMessageTransferSidelink message

```
-- ASN1START
-- TAG-UUMESSAGETRANSFERSIDELINK-START
UuMessageTransferSidelink-r17 ::= SEQUENCE {
  criticalExtensions CHOICE {
    uuMessageTransferSidelink-r17 UuMessageTransferSidelink-r17-IEs,
    criticalExtensionsFuture SEQUENCE { }
  }
}
UuMessageTransferSidelink-r17-IEs ::= SEQUENCE {
  sl-PagingDelivery-r17 OCTET STRING (CONTAINING PagingRecord) OPTIONAL, --
Need N
  sl-SIB1-Delivery-r17 OCTET STRING (CONTAINING SIB1) OPTIONAL, --
Need N
  sl-SystemInformationDelivery-r17 OCTET STRING (CONTAINING
SystemInformation)OPTIONAL,-- Need N
  lateNonCriticalExtension OCTET STRING OPTIONAL,
  nonCriticalExtension UuMessageTransferSidelink-vxx-IEs OPTIONAL
}
UuMessageTransferSidelink-vxx-IEs::= SEQUENCE {
sl-PagingDelivery-vxx OCTET STRING (CONTAINING PagingRecord-vxx) OPTIONAL, -
- Need N
  nonCriticalExtension SEQUENCE { } OPTIONAL
}
-- TAG-UUMESSAGETRANSFERSIDELINK-STOP
-- ASN1STOP
```

Another example of encoding UuMessageTransferSidelink message is as follows:

```
UuMessageTransferSidelink-r17-IEs ::= SEQUENCE {
sl-PagingDelivery-r17 OCTET STRING (CONTAINING PagingRecord) OPTIONAL, --
Need N
sl-SIB1-Delivery-r17 OCTET STRING (CONTAINING SIB1) OPTIONAL, -- Need
N
sl-SystemInformationDelivery-r17 OCTET STRING (CONTAINING
SystemInformation)OPTIONAL,-- Need N
  lateNonCriticalExtension OCTET STRING OPTIONAL,
  nonCriticalExtension UuMessageTransferSidelink-vxx-IEs OPTIONAL
}
UuMessageTransferSidelink-vxx-IEs::= SEQUENCE {
  sl-PagingDelivery-vxx OCTET STRING (CONTAINING sl-PagingRecord) OPTIONAL, -
- Need N
  nonCriticalExtension SEQUENCE { } OPTIONAL
}
sl-PagingRecord ::= SEQUENCE {
  ue-Identity PagingUE-Identity,
  accessType ENUMERATED {non3GPP} OPTIONAL, -- Need N
    sdt-MT-r18 ENUMERATED {true} OPTIONAL -- Need N
}
```

If a relay UE receives a paging cause for a remote UE in a paging message received from the gNB, it includes sl-PagingDelivery-vxx in UuMessageTransferSidelink instead of sl-PagingDelivery-r17.

Another example of encoding UxMessage TransferSidelink message is as follows:

```
UuMessageTransferSidelink-r17-IEs ::= SEQUENCE {
dummy OCTET STRING (CONTAINING PagingRecord) OPTIONAL, -- Need N
sl-SIB1-Delivery-r17 OCTET STRING (CONTAINING SIB1) OPTIONAL, -- Need
N
sl-SystemInformationDelivery-r17 OCTET STRING (CONTAINING
SystemInformation)OPTIONAL,-- Need N
  lateNonCriticalExtension OCTET STRING OPTIONAL,
  nonCriticalExtension UuMessageTransferSidelink-vxx-IEs OPTIONAL
}
UuMessageTransferSidelink-vxx-IEs::= SEQUENCE {
  sl-PagingDelivery-vxx OCTET STRING (CONTAINING sl-PagingRecord) OPTIONAL, -
- Need N
  nonCriticalExtension SEQUENCE { } OPTIONAL
}
sl-PagingRecord ::= SEQUENCE {
  ue-Identity PagingUE-Identity,
  accessType ENUMERATED {non3GPP} OPTIONAL, -- Need N
  sdt-MT-r18 ENUMERATED {true} OPTIONAL -- Need N
}
```

If a relay UE receives a ue-identity of a remote UE in a paging message received from the gNB, it includes sl-PagingDelivery-vxx in UuMessageTransferSidelink.

Another example of encoding UuMessageTransferSidelink message is as follows:

```
    UuMessageTransferSidelink-r17-IEs ::= SEQUENCE {
dummy OCTET STRING (CONTAINING PagingRecord) OPTIONAL, -- Need N
sl-SIB1-Delivery-r17 OCTET STRING (CONTAINING SIB1) OPTIONAL, -- Need
N
sl-SystemInformationDelivery-r17 OCTET STRING (CONTAINING
SystemInformation)OPTIONAL,-- Need N
  lateNonCriticalExtension OCTET STRING OPTIONAL,
  nonCriticalExtension UuMessageTransferSidelink-vxx-IEs OPTIONAL
}
UuMessageTransferSidelink-vxx-IEs::= SEQUENCE {
  sl-PagingDelivery-vxx OCTET STRING (CONTAINING PagingMessage) OPTIONAL, --
Need N
  nonCriticalExtension SEQUENCE { } OPTIONAL
}
```

If a relay UE receives a paging message including ue-identity of a Remote UE from the gNB, it generates a new PagingMessage including only the remote UE's info and includes this PagingMessage in UuMessageTransferSidelink.

A new type of lower layer mobility also referred to as L1/L2-triggered mobility (LTM) is being investigated. The Lower Layer Mobility is based on L1 measurements that are provided by the UE to the serving cell. Based on these measurements handover is triggered by sending a L1 (e.g., DCI) or L2 (e.g., MAC CE) command. In Lower Layer Mobility, the serving cell change is triggered based on L1 beam measurements instead of L3 cell power and quality measurements that are configured in NR baseline handover of Rel. 15. L3 cell quality measurements are reported only after some Time-to-Trigger (TTT) expires for a measurement event. L3 measurements are also filtered based on the L3 configuration over multiple measurements before reporting. L1 measurements have the benefit that the network can react faster to radio link degradation in the serving link as the network can save the delay introduced by L3 filtering and TTT for the handover decision. This should result in reducing in the number of radio link failures compared to baseline handover.

In the legacy handover procedure, RRC procedure delay comprises RRC signal processing related to decoding of handover command and L2/3 reconfiguration of the protocol layers. For lower layer mobility, RRC procedure delay can be reduced given that the UE can receive and decode the configuration of the target cells before the cell change occurs. Moreover, since lower layer mobility is restricted to the intra-CU scenario with the same PDCP and RRC, L2/3 reconfigurations can be minimized by keeping the same configuration for PDCP and RRC and possibly other layers such as RLC and MAC in the intra-DU scenario, i.e., in the inter-DU scenario the new target cell may have different configurations for RLC and MAC. In the best case for intra-DU, the target cell can reconfigure only the new C-RNTI which can save the entire L2/3 reconfiguration for the UE.

In the legacy handover procedure there is delay due to RF/baseband retuning, derivation of target gNB security keys and configuration of the security algorithm to be used in the target cell. These can also be avoided in lower layer mobility. Given that the PDCP entity in the CU is the same for both the source and target cells, the same security keys and algorithms can be applied which reduces the interruption time.

For LTM, the serving cell can configure UE with one or more candidate LTM cells. A PDCCH ordered RA can be sent to the UE to trigger a RACH for early TA maintenance of the candidate LTM cells so that at the time of the LTM cell switch, latency due to the RACH can be avoided.

As per the current operation, the UE receives the PDCCH order for a LTM's candidate cell amongst one or more LTM candidate cells configured to the UE by the gNB for the LTM. Upon receiving the PDCCH order:
The UE initiates a random access procedure. The UE initializes PREAMBLE_TRANSMISSION_COUNTER to zero. The UE initializes PREAMBLE_POWER_RAMPING_COUNTER to zero.
The UE transmits a PRACH preamble. The UE calculates PREAMBLE_RECEIVED_TARGET_POWER

PREAMBLE_RECEIVED_TARGET_POWER to preamble ReceivedTargetPower+DELTA_PREAMBLE+(PREAMBLE_POWER_RAMPING_COUNTER−1)×PREAMBLE_POWER_RAMPING_STEP
Transmission power is then calculated by the physical layer based on PREAMBLE_RECEIVED_TARGET_POWER, path loss etc.
Upon PRACH preamble transmission, the random access procedure is considered completed.

The issue with the current operation is that power ramping is not applied. The UE transmits using the same power for initial transmission. Note that PDCCH order may indicate initial transmission or retransmission.

In an embodiment, operation upon reception of PDCCH order for a LTM's candidate cell can be as follows:

The UE receives a PDCCH order for a LTM's candidate cell amongst one or more LTM candidate cells configured to the UE by the gNB for LTM. Upon receiving the PDCCH order, the UE initiates a random access procedure. If initial transmission (i.e., the transmission indicator in the PDCCH order indicates first or initial transmission) is indicated in the PDCCH order for the LTM's candidate the UE initializes cell, PREAMBLE_TRANSMISSION_COUNTER to 1, and the UE initializes PREAMBLE_POWER_RAMPING_COUNTER to 1. If the transmission indicator in the PDCCH order indicates retransmission and the last random access procedure (if any) was for a serving cell/candidate cell different from the candidate cell of this random access procedure, or if this is the first PDCCH order received for the candidate LTM cell and PDCCH order indicates retransmission (this means that the UE has missed the PDCCH order indicating initial transmission for this candidate cell): the UE initializes PREAMBLE_TRANSMISSION_COUNTER to 1, and the UE initializes PREAMBLE_POWER_RAMPING_COUNTER to 1. Note that the UE is in the RRC_CONNECTED state and the random access procedure towards the serving cell can be initiated by the UE (e.g., for a scheduling request) or can be initiated by the network.

Otherwise, if the transmission indicator in PDCCH order indicates retransmission (or if transmission indicator in PDCCH order indicates retransmission and listen before talk (LBT) failure was not determined for last random access preamble transmission to the candidate cell), the UE increments PREAMBLE_TRANSMISSION_COUNTER by 1 (or the UE initializes PREAMBLE_TRANSMISSION_COUNTER to a pre-defined value e.g., preambleTransMax or any other value; the UE initializes PREAMBLE_TRANSMISSION_COUNTER to value configured by gNB in RRC signaling e.g., in LTM configuration), and the UE increments PREAMBLE POWER_RAMPING_COUNTER by 1 (or the UE initializes PREAMBLE_TRANSMISSION_COUNTER to a pre-defined value e.g., preamble TransMax or any other value; the UE initializes PREAMBLE_POWER_RAMPING_COUNTER to value configured by gNB in RRC signaling e.g., in LTM configuration).

The UE transmits a PRACH preamble. The UE calculates PREAMBLE_RECEIVED_TARGET_POWER for PRACH preamble transmission as follows:

PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP
Transmission power is then calculated by the physical layer based on PREAMBLE_RECEIVED_TARGET_POWER, path loss etc.

Upon PRACH preamble transmission, the random access procedure is considered completed. If the LTM candidate cell to which the UE transmits the random access preamble is operating on unlicensed spectrum and the PRACH preamble could not be transmitted due to LBT failure, the UE may retransmit the PRACH preamble towards the LTM candidate cell without increasing PREAMBLE_POWER_RAMPING_COUNTER.

In one embodiment, if the random access procedure is completed:

If the random access procedure was for the Serving Cell (i.e., non-candidate LTM cell): the UE initializes PREAMBLE_TRANSMISSION_COUNTER to 1, and the UE initializes PREAMBLE_POWER_RAMPING_COUNTER to 1. Otherwise, (If the random access procedure was for candidate LTM cell): the UE does not initialize PREAMBLE_TRANSMISSION_COUNTER to 1, and the UE does not initialize PREAMBLE_POWER_RAMPING_COUNTER to 1.

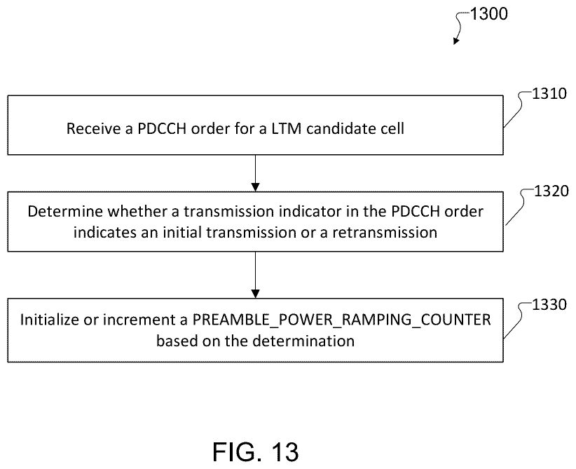

FIG. 13 illustrates a method 1300 for preamble power ramping adjustment according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments for preamble power ramping adjustment could be used without departing from the scope of this disclosure.

In the example of FIG. 13, the method begins at step 1310. At step 1310, a UE such as UE 116 of FIG. 1 receives a PDCCH order for a LTM candidate cell. At step 1320, the UE determines whether a transmission indicator in the PDCCH order indicates an initial transmission or retransmission. Finally, at step 1303, the UE either initializes or increments a PREAMBLE_POWER_RAMPING_COUNTER based on the determination.

Although FIG. 13 illustrates one example of a method 1300 for preamble power ramping adjustment, various changes may be made to FIG. 13. For example, while shown as a series of steps, various steps in FIG. 13 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to receive a primary downlink control channel (PDCCH) order for a layer1/layer2 triggered mobility (LTM) candidate cell; and
a processor operatively coupled to the transceiver, the processor configured to:
determine, whether a transmission indicator in the PDCCH order indicates an initial transmission or a retransmission; and
initialize or increment a PREAMBLE_POWER_RAMPING_COUNTER based on the determination.

2. The UE of claim 1, wherein when the processor determines that the transmission indicator in the PDCCH order indicates an initial transmission, the processor is further configured to initialize the PREAMBLE_POWER_RAMPING_COUNTER to 1.

3. The UE of claim 1, wherein when the processor determines that the transmission indicator in the PDCCH order indicates a retransmission and the PDCCH order is a first PDCCH order received for the LTM candidate cell, the processor is further configured to initialize the PREAMBLE_POWER_RAMPING_COUNTER to 1.

4. The UE of claim 1, wherein:
when the processor determines that the transmission indicator in the PDCCH order indicates a retransmission, the processor is further configured to determine whether a last random access procedure was for a serving cell or candidate cell different from the LTM candidate cell; and
the processor is further configured to initialize the PREAMBLE_POWER_RAMPING_COUNTER to 1 when the processor determines that last random access procedure was for the serving cell or candidate cell different from the LTM candidate cell.

5. The UE of claim 1, wherein when the processor determines that the transmission indicator in the PDCCH order indicates a retransmission and the PDCCH order is not a first PDCCH order received for the LTM candidate cell, the processor is further configured to increment the PREAMBLE_POWER_RAMPING_COUNTER by 1.

6. The UE of claim 1, wherein when the processor determines that the transmission indicator in the PDCCH order indicates a retransmission and the PDCCH order is not a first PDCCH order received for the LTM candidate cell, the processor is further configured to initialize the PREAMBLE_POWER_RAMPING_COUNTER to a pre-defined value.

7. The UE of claim 1, wherein when the processor determines that the transmission indicator indicates retransmission and a listen before talk (LBT) failure was not determined for a last random access preamble transmission to the LTM candidate cell, the processor is further configured to increment the PREAMBLE_POWER_RAMPING_COUNTER by 1.

8. The UE of claim 1, wherein when the processor determines that the transmission indicator indicates retransmission and a listen before talk (LBT) failure was not determined for a last random access preamble transmission to the LTM candidate cell, the processor is further configured to initialize the PREAMBLE_POWER_RAMPING_COUNTER to a pre-defined value.

9. A method of operating a user equipment (UE), the method comprising:
receiving a primary downlink control channel (PDCCH) order for a layer1/layer2 triggered mobility (LTM) candidate cell;
determining, whether a transmission indicator in the PDCCH order indicates an initial transmission or a retransmission; and
initializing or incrementing a PREAMBLE_POWER_RAMPING_COUNTER based on the determination.

10. The method of claim 9, wherein when the transmission indicator in the PDCCH order indicates an initial transmission, the method further comprises initializing the PREAMBLE_POWER_RAMPING_COUNTER to 1, the method further comprises.

11. The method of claim 9, wherein when the transmission indicator in the PDCCH order indicates a retransmission and the PDCCH order is a first PDCCH order received for the LTM candidate cell, the method further comprises initializing the PREAMBLE_POWER_RAMPING_COUNTER to 1.

12. The method of claim 11, further comprising:
determining whether a last random access procedure was for a serving cell or candidate cell different from the LTM candidate cell; and
initializing the PREAMBLE_POWER_RAMPING_COUNTER to 1 when the last random access procedure was for the serving cell or candidate cell different from the LTM candidate cell.

13. The method of claim 9, wherein when the transmission indicator in the PDCCH order indicates a retransmission and the PDCCH order is not a first PDCCH order received for the LTM candidate cell, the method further comprises incrementing the PREAMBLE_POWER_RAMPING_COUNTER by 1.

14. The method of claim 9, wherein when the transmission indicator in the PDCCH order indicates a retransmission and the PDCCH order is not a first PDCCH order received for the the method further comprises initializing the LTM candidate cell, PREAMBLE_POWER_RAMPING_COUNTER to a pre-defined value.

15. The method of claim 9, wherein when the transmission indicator indicates retransmission and a listen before talk (LBT) failure was not determined for a last random access preamble transmission to the LTM candidate cell, the method further comprises incrementing the PREAMBLE_POWER_RAMPING_COUNTER by 1.

16. The method of claim 9, wherein when the transmission indicator indicates retransmission and a listen before talk (LBT) failure was not determined for a last random access preamble transmission to the LTM candidate cell, the method further includes initializing the PREAMBLE_POWER_RAMPING_COUNTER to a pre-defined value.

17. A user equipment (UE) comprising:
a transceiver;
a processor operatively coupled to the transceiver, the processor configured to, during an ongoing small data transfer (SDT) procedure:
determine whether a synchronization signal-reference signal received power (SS-RSRP) of a synchronization signal block (SSB) selected in a last successfully completed random access procedure during the ongoing SDT procedure is below a threshold; and
determine whether a prohibit timer is configured and not running.

18. The UE of claim 17, wherein if the processor determines that the SS-RSRP of the SSB is below a threshold, and the processor determines that the prohibit timer is configured and not running, the processor is further configured to:
initiate a random access procedure; and
start the prohibit timer.

19. The UE of claim 17, wherein:
the transceiver is configured to receive a system information message; and
the system information message includes a configuration for the prohibit timer.

20. The UE of claim 17, wherein if the processor determines that the SS-RSRP of the SSB is below a threshold, and the processor determines that the prohibit timer is configured and not running, and the processor determines that there is at least one SSB with SS-RSRP above a threshold, the processor is further configured to:
initiate a random access procedure; and
start the prohibit timer.
